(19) United States
(12) Patent Application Publication
(10) Pub. No.: US 2017/0211023 A1
(43) Pub. Date: Jul. 27, 2017

(54) SUPRAMOLECULAR CAPSULES

(71) Applicant: Aqdot Ltd, Cambridge, Cambridgeshire (GB)

(72) Inventor: Jing ZHANG, Cambridge (GB)

(73) Assignee: Aqdot Ltd, Cambridge, Cambridgeshire (GB)

(21) Appl. No.: 15/328,257

(22) PCT Filed: Jul. 21, 2015
(86) PCT No.: PCT/GB2015/052106

§ 371 Date: Jan. 23, 2017

(30) Foreign Application Priority Data
Jul. 22, 2014 (GB) 1412955.5

(51) Int. Cl. C11D 17/00; C11D 3/386; B01J 35/12; B01J 13/18; B01J 31/00

(52) U.S. Cl. CPC C11D 17/0039; B01J 13/18; B01J 31/003; B01J 35/12; C11D 3/386; C11D 3/38645; C11D 3/38636; B01J 2531/002

(57) ABSTRACT

Provided is the use of a capsule holding a catalyst, such as an enzyme. The capsule has a shell of material that is a supramolecular cross-linked network. The network is formed from a host-guest complexation of a host, such as cucurbituril, and one or more building blocks comprising suitable guest functionality. The complex non-covalently crosslinks the building block and/or non-covalently links the building block to another building block thereby forming the network. The shell of the capsule encapsulates the catalyst. The capsules holding the catalyst are suitable for use as microreactors, and the catalyst can be used as such whilst it is held within the capsule.

### FIELD OF THE INVENTION

This invention relates to capsules, particularly microcapsules, holding a catalyst. The capsule is based on a cucurbituril cross-linked network, and described are methods for the preparation of such capsules, and their use in methods of synthesis, and methods for delivering encapsulated catalysts.

### BACKGROUND

The microencapsulation of components within a shell that is a supramolecular network is described in WO 2013/014452. The shell is obtainable from the complexation of a composition comprising a host, such as cucurbituril, and one or more building blocks, such as polymers or particles, having suitable guest functionality for the host. The complexation of the host with the guest functionality forms a supramolecular cross-linked network.

The capsule is prepared using fluidic techniques. Thus, a flow of a first phase and a flow of a second phase are contacted in a channel, thereby to generate in the channel a dispersion of discrete regions, typically droplets, of the second phase in the first phase. The second phase comprises the host and one or more building blocks having suitable guest functionality. The supramolecular cross-linked network is formed at the boundary of the discrete region with the continuous phase. The first and second phases are immiscible.

The capsule may hold a component within the shell. In the worked examples it is shown that a dextran molecule may be incorporated into the capsule. Labelled dextran molecules may be released from the capsules through pores in the shell. Here, the pore size is larger than the size of the encapsulated component.

Alternatively, the dextran molecules may be retained in the capsule, and may be later released by disruption of the supramolecular cross-linked network. Here, the pore size is smaller than the size of the encapsulated component. The ratio of capsule shell components may be varied in order to customize the pore size for the encapsulated component.

Also described in WO 2013/014452 is the encapsulation of a microorganism in a capsule.

The component to be encapsulated may be provided together with the host and the building blocks in the second phase. The formation of the supramolecular cross-linked network encapsulates the component.

WO 2013/014452 describes the delivery of a component to a desirable location using a supramolecular capsule. Thus, a capsule having a shell encapsulating a component is provided, and the capsule is delivered to a target location. The component is then released from the shell at the target location. The component may be released in response to an external stimulus or in response to local conditions at the target location. An external stimulus may be provided by the addition of a competitor guest compound. The competitor guest molecule displaces a guest molecule of a building block thereby to disrupt the network that forms the capsule shell. Such disruption may cause pores to appear in the shell, through which the encapsulated compound may pass through and be released. The competitor guest compound is capable of causing an extensive disruption of the capsule shell.

Thus, WO 2013/014452 describes the encapsulation of a component into, and release of a component from, a supramolecular capsule.

Related to WO 2013/014452 is PCT/GB2014/050259, which describes nested supramolecular capsules. Here, a nested capsule comprises a first capsule held within a second capsule, and each of the first and second capsules has a shell that is a supramolecular cross-linked network. Each shell is obtainable from the complexation of a composition comprising a host, such as cucurbituril, and one or more building blocks, such as a polymeric molecule, having suitable guest functionality, thereby to form a supramolecular cross-linked network.

Each capsule within the nested capsule may hold a component. The nested capsule may be used to deliver the component to a desired location.

Thus, PCT/GB2014/050259 also describes the encapsulation of a component into and release of a component from a supramolecular capsule.

### SUMMARY OF THE INVENTION

The present invention generally provides for the use of a capsule holding a catalyst, where the capsule has a shell of material that is a supramolecular cross-linked network. The network is formed from a host-guest complexation of a host, such as cucurbituril, and one or more building blocks comprising suitable guest functionality. The complex non-covalently crosslinks the building block and/or non-covalently links the building block to another building block thereby forming the network. The shell of the capsule encapsulates the catalyst. Typically the catalyst is an enzyme.

The inventors have found that a supramolecular capsule holding a catalyst may be used as a microreactors, and the catalyst may be used as such whilst it is held within the capsule.

In one aspect there is provided a method of catalysis, the method comprising the step of catalysing the reaction of a reagent in the presence of a catalyst, wherein a capsule holds the catalyst, and the capsule has a shell of material that is a supramolecular cross-linked network.

In one embodiment, the method comprises the preliminary step of permitting the reagent to enter the capsule. Thus, a reagent is provided into the capsule only after the capsule shell is formed. In this embodiment, a reagent is not provided with the catalyst during the shell forming step.

In one embodiment, the method comprises the steps of:
(i) providing a capsule having a shell which is obtainable from the complexation of a composition comprising a host, such as cucurbituril, and one or more building blocks having suitable guest functionality thereby to form a supramolecular cross-linked network, wherein the capsule encapsulates a catalyst;
(ii) bringing one or more reagents into contact with the encapsulated catalyst, thereby allowing the catalyst to catalyse the reaction of the one or more reagents.

In one embodiment, the catalyst is an enzyme.

In one embodiment, the host is selected from cucurbituril, cyclodextrin, calix[n]arene, and crown ether, and the one or more building blocks have suitable guest functionality for the cucurbituril, cyclodextrin, calix[n]arene or crown ether host. In one embodiment the host is a cucurbituril host.

For example, the host is cucurbituril and the one or more building blocks have suitable guest functionality for the cucurbituril. In one embodiment, the cucurbituril is CB[8].

In a further aspect there is provided a cleaning composition comprising a capsule having a shell which is obtainable from the complexation of a composition comprising a host, such as cucurbituril, and one or more building blocks having suitable guest functionality thereby to form a supramolecular cross-linked network, wherein the capsule encapsulates a component such as a catalyst.

The cleaning composition may be a detergent composition, a laundry composition or a dishwashing composition.

In one embodiment, the catalyst is an enzyme.

In another aspect there is provided the use of a cleaning composition for cleaning laundry or dishes (including cutlery and crockery and so on), wherein the cleaning composition comprising a capsule having a shell which is obtainable from the complexation of a composition comprising a host, such as cucurbituril, and one or more building blocks having suitable guest functionality thereby to form a supramolecular cross-linked network, wherein the capsule encapsulates a component such as a catalyst.

In one aspect there is provided a method of releasing an encapsulant from a capsule, the method comprising the steps of:
(i) providing a capsule having a shell which is obtainable from the complexation of a composition comprising a host, such as cucurbituril, and one or more building blocks having suitable guest functionality thereby to form a supramolecular cross-linked network, wherein the capsule encapsulates a component;
(ii) diluting the capsule, thereby to release the encapsulant from the capsule.

In one embodiment, step (i) includes subsequently drying the formed capsule thereby to reduce the water content of the capsule. The capsule may be dried to give a capsule that is substantially free of water.

In one embodiment, the capsule is diluted in water, such as an aqueous solution.

The inventors have found that capsules having a surprisingly small amount of shell material may be used to hold a component. Thus the weight percentage of the component as a percentage of the total weight of the component and the capsule shell is relatively high. Accordingly, the weight percentage of shell materials (the host and the building blocks together) is relatively low.

In a further aspect there is provided a capsule having a shell which is obtainable from the complexation of a composition comprising a host, such as cucurbituril, and one or more building blocks having suitable guest functionality thereby to form a supramolecular cross-linked network, wherein the capsule holds a component, and component is present at 50 wt % or more as a percentage of the total amount of component and the capsule shell.

In one embodiment, the component is present at 60 wt % or more, such as 70, 80, 85, 90 or 95 wt % or more, as a percentage of the total amount of component and the capsule shell.

The inventors have found that capsules can hold a relatively large amount of component, and that component may be held without degradation of the capsule shell or the component. Thus, the component retains its activity, such as catalytic activity, and may be used as an active component either within the capsule or after its release from the capsule.

In another aspect there is provided a capsule holding a component, such as a catalyst, wherein the capsule has a shell which is obtainable from the complexation of a composition comprising a host, such as cucurbituril, and one or more building blocks having suitable guest functionality thereby to form a supramolecular cross-linked network, wherein the component is present at a concentration of at least 0.5, at least 1, at least 2, at least 5, at least 10, or at least 20 mg/mL.

In one embodiment, the component is a catalyst.

In one embodiment, the component is an enzyme.

In one embodiment, the average shell thickness of the capsule shell is at most 20, at most 10, or at most 5 μm.

### SUMMARY OF THE FIGURES

FIG. 1 is a series of light microscopic images of the formation of microcapsules containing α-amylase for use according to an embodiment of the invention, where (a) is an image of droplets as the capsule shell first begins to form at each droplet boundary; and (bare image of capsules structures obtained from the droplets in (a) after dehydration, where the capsules have a smaller and shrivelled structure. The capsules are shown floating in an oil phase at different focal planes.

FIG. 2 shows the change in relative activity (%) of α-amylase under different conditions, where the α-amylase is used in free form in buffer, or is provided within a capsule as described herein or within a fluidic droplet (i.e. where no capsule shell is present).

FIG. 3 shows the changes in relative activity (%) of an alkaline phosphatase over time (h) under different conditions, where the alkaline phosphatase is provided within a capsule as described herein (diamonds) or within a fluidic microdroplet (i.e. where no capsule shell is present) (squares). Alkaline phosphatase provided in microdroplets loses all activity upon incorporation into the droplet. In contrast alkaline phosphatase encapsulated into capsules retains significant activity over time.

FIG. 4 is a series of light microscopic images (left) and fluorescence images (right) of microcapsules containing lipase for use according to an embodiment of the invention, where the top images show dehydrated capsules formed from a droplet having a diameter of 60 μm; and the bottom images show rehydrated capsules prepared from the dehydrated capsules by rehydration in TRIS buffer. The scale bar is 20 μm.

FIG. 5 shows the change in relative activity (%) of a lipase over time (h) under different conditions, where the lipase is used in free form in buffer, or is provided within a capsule as described herein.

FIG. 6 (a) is a fluorescence image of supramolecular microcapsules containing FITC-dextran as a model cargo; and (b) shows the change in relative fluorescence intensity (%) over time (months) for microcapsules stored over 6 months at room temperature in an off-the-shelf formulation. The retention of fluorescence intensity of FITC-dextran as a model cargo indicates the integrity of the capsule shell over the duration of the experiment.

FIG. 7 is a series of fluorescence images showing the release of FITC-dextran from microcapsules over time (0 to 5 minutes) in response to the addition of 1-adamantamine as a competitive guest. Capsules that had been stored for 6 months were used. The scale bar is 20 μm.

FIG. 8 is a series of bright field and fluorescence images of lipase-containing capsules before and during storage in a liquid laundry detergent (a commercially available detergent was used). The scale bar is 50 μm. The before images are left and centre, and the during image is right.

### DETAILED DESCRIPTION OF THE INVENTION

Some of the present inventors have previously described the preparation of capsules having a shell of material that is a supramolecular cross-linked network. See, for example, WO 2013/014452 and Zhang et al., the contents of both of which are hereby incorporated by reference in their entirety. Some of the present inventors have also previously described the preparation of nested supramolecular capsules, where a first capsule is held within a second capsule and each of the first and second capsules has a shell that is a supramolecular cross-linked network. See, for example, PCT/GB2014/050259, the contents of which are hereby incorporated by reference in its entirety.

The capsules described in WO 2013/014452, PCT/GB2014/050259 and Zhang et al. find use in the methods of catalysis as described in this case. WO 2013/014452 and PCT/GB2014/050259 describe the encapsulation of a component in a capsule. Where that component is a catalyst, such as an enzyme, it may be used in a method of catalysis as described herein.

In other aspects of the invention there are provided capsules that differ from those capsules described in WO 2013/014452 and PCT/GB2014/050259. The capsules of the invention typically encapsulate a component, such as a catalyst, at a very high loading, for example where the catalyst is present at 0.5 mg/mL or more, and/or the catalyst is present at 50 wt % or more as a percentage of the total amount of component and the capsule shell.

In their earlier work some of the present inventors have established that supramolecular capsules may be used to hold components for later delivery. The inventors have found that, alternatively, a component that is encapsulated in a capsule may be used within the capsule to good effect. Thus, where a catalyst is encapsulated in a capsule, the catalyst may be used as such within the capsule. Thus it is not necessary to release the component from the capsule in order to make use of the component's activity, such as catalytic activity.

There are benefits to this approach. For example, the capsule provides protection for the catalyst, and that protection is retained whilst the catalyst is in use.

The reagents for use in a catalysis reaction maybe permitted to enter the capsule, and after catalysis the products may be permitted to exit the capsule. The catalyst may be retained in the capsule throughout. Thus, the purification of the products from the catalyst simply requires the trivial separation of the capsule from the medium in which the capsules are provided. This avoids the complicated separation procedures that are often necessary where a catalyst, such as an enzyme, is used directly in a reaction medium.

The fluidic preparation methods that are described herein allow for the preparation of capsules that have a high level of homogeneity. Such methods also result in the encapsulation of components at known concentrations and at quantities that are highly similar between capsules. Such homogeneity increases predictability and reduces variation in the catalysis reaction.

The present inventors have found that the capsules described in WO 2013/014452 and PCT/GB2014/050259 may be beneficially adapted to hold catalysts for later delivery to a desired location. The inventors have found that a component such as a catalyst may be provided at a surprisingly high concentration within a capsule. At this high concentration the encapsulated component may be stored and released as required. Where the component is a catalyst, the catalyst retains activity and may be used as a catalyst whilst encapsulated or the catalyst may be released.

The work described in WO 2013/014452 typically makes use of a capsule of 60 μm in diameter, which has an internal volume of 1.1×10⁻¹³ m³ (1.1×10⁻¹⁰ L). The capsules were shown to be capable of holding FTIC-labelled dextran molecules having molecular weights from 10,000 to 500,000 Da. The dextran was used at a concentration of 25% v/v in an aqueous solution also comprising CB[8], MV²⁺-AuNP, and Np-RD-pol. This is a concentration of dextran of around 2.5 μM.

The present inventors have also found that the integrity of the capsule is maintained where the shell material has a relatively low quantity of material relative to the amount of encapsulated component present. Thus, the weight percentage of the shell is low, and conversely the weight percentage of the component is high. Therefore it is not necessary to use large amounts of complexable material in order to maintain the encapsulation of components held within the capsule. It will be appreciated that the use of low quantities of material (for example, hosts, guests, and building blocks), reduces the overall cost of the capsule.

Furthermore, reducing the amount of material in a capsule shell may assist the release of an encapsulated component. The release of an encapsulated component from a supramolecular capsule typically involves the disruption of the non-covalent interaction between a host and its guest or guests. Such disruption must be sufficient to allow for encapsulated component to pass through the shell at a site of disruption. Reducing the amount of material in the shell allows the encapsulated material to be rapidly released and with greater ease.

Earlier work from some of the present inventors in WO 2013/014452 discusses the use of a capsule as a microreactor. However, this disclosure is limited to the reaction of components (reagents) that are encapsulated into the capsule simultaneously with the formation of the capsule shell. Thus, all the reagents are provided in a second fluid stream that is ultimately dispersed in a continuous phase of an immiscible first fluid. It is at the boundary of the phases that the shell is formed, thereby encapsulating the reagents, which are permitted to react within the internal space of the formed shell. The earlier work does not describe the use of a catalyst within the capsule.

In contrast the present case provides a capsule holding a catalyst, and making use of that catalyst to catalyse the reaction of one or more reagents within the internal space. The use of a catalyst in this way is not described in WO 2013/014452. Furthermore, in preferred embodiments, a reagent is permitted to enter the capsule only after the shell is formed. In this way the catalyst is permitted to function only when the capsule is contacted with reagent.

### Capsules

A capsule has a shell of material. The material is the supramolecular complex that is formed from the complexation of a host, such as cucurbituril, with building blocks covalently linked to appropriate guest molecules. The shell defines an internal space, which may be referred to as a hollow space, which is suitable for holding a catalyst. Thus, in one embodiment, the capsules for use in the invention extend to those capsules encapsulating a catalyst within the shell. The shell may form a barrier limiting or preventing the release of catalyst encapsulated within. As described herein, reagents may be permitted to pass into the capsule internal space for contact with the catalyst, which may catalyse the reaction of the reagent thereby to form a product. The product may be permitted to pass out of the capsule internal space, away from the internalised catalyst.

In one embodiment, a capsule holds a component, such as a catalyst, for subsequent release. A component may be releasable from the capsule through pores that are present in the shell. In some embodiments, the pores are sufficiently small to prevent the component from being released. Thus, the network making up the shell can be at least partly disassembled to permit release of material from within the shell. Further pores may be generated by the application of an external stimulus to the shell. In this case, the pores may be generated through a disruption of the host-guest complex, such as the cucurbituril-guest complex. Such decomplexation therefore creates pores through which encapsulated components may be released from within the shell. In some embodiments of the invention, the shell material may subsequently be reformed by reassembly of the shell components.

In one embodiment, a capsule holds water within the shell. The water may be an aqueous solution comprising one or more of the reagents that are for use in the preparation of the supramolecular shell i.e. unreacted reagents. In one embodiment, the capsule is at least partially dehydrated.

Where the capsule is said to encapsulate a component, such as a catalyst, it is understood that that this encapsulated component may be present within the internal space defined by the shell. In one embodiment, the encapsulant is also present, at least partially, within the pores of the shell.

The presence of a component, such as a catalyst, within the shell and/or within the pores of the shell may be determined using suitable analytical techniques which are capable of distinguishing the shell material and the encapsulant. For example, each of the shell material and the component may have a detectable label or suitable functionality that is independently detectable (orthogonal) to the label or functionality of the other. In one embodiment, each of the shell and the component has an orthogonal fluorescent label. For example, one has a rhodamine label and the other has a fluorescein label. Laser scanning confocal microscopy techniques may be used to independently detect the fluorescence of each label, thereby locating each of the shell and encapsulant. Where the component signals are located at the same point as the signals from the shell, it is understood that the component resides within a pore of the shell.

The general shape of the shell, and therefore the shape of the capsule, is not particularly limited. In practice however, the shape of the capsule may be dictated by its method of preparation. In the preparation methods described herein, a capsule shell may be prepared using fluidic droplet formation techniques. Typically, the shell material is formed at the boundary of a discrete (or discontinuous) phase in a continuous phase. For example, one phase may be an aqueous phase, and the other may be a water immiscible phase. The discrete region may be a droplet, having a substantially spherical shape. The shell formed is therefore also substantially spherical.

In certain embodiments, a capsule may be obtained when the shell has a substantially spherical shape. This capsule may be subjected to a drying step, which reduces the amount of solvent (for example, water) in and around the capsule. As a result of this step, the capsule shrinks in size. At first the shell maintains a substantially spherical shape. After further drying, the capsule sphere may partially or fully collapse in on itself. The structural integrity of the capsule is maintained and the shell simply distorts to accommodate changes in the internal volume. Thus, the capsules of the invention include those capsules where the shell is an at least partially collapsed sphere.

Given the formation of the capsule shell at the boundary of the discrete region (for example, a droplet), references to the dimensions of a droplet may also be taken as references to the dimension of the capsule. The capsule shell may form prior to a drying step.

The inventors have established that capsules that have been shrunk, for example by desolvation, may subsequently be returned to their original substantially spherical shape, by, for example, resolvating the capsule.

In certain embodiments, resolvating the capsule at high dilution levels will advantageously disrupt the supramolecular network, thereby allowing the release of encapsulated component.

The shape of a capsule may be determined by simple observation of the formed capsule using microscopy, such as bright field microscopy, scanning electron microscopy or transmission electron microscopy. Where the shell material comprises a label, the detection of the label through the shell will reveal the capsule shape. For example, where the label is a fluorescent label, laser scanning confocal microscopy may be used to locate the shell material and its shape.

The size of the capsule is not particularly limited. In one embodiment, the capsule is a microcapsule and/or a nanocapsule.

In one embodiment, each capsule has an average size of at least 0.1, 0.2, 0.5, 0.7, 1, 5, 10, 20, 30, 40, 50, 100 or 200 μm in diameter.

In one embodiment, each capsule has an average size of at most 400, 200, 100, 75 or 50 μm in diameter.

In one embodiment, the capsule size is in a range where the minimum and maximum diameters are selected from the embodiments above. For example, the capsule size is in range from 10 to 100 μm in diameter.

Average size refers to the numerical average of measured diameters for a sample of capsules. Typically, at least 5 capsules in the sample are measured. A cross section measurement is taken from the outmost edges of the shell.

The cross-section of a capsule may be determined using simple microscopic analysis of the formed capsules. For example, the formed capsules may be placed on a microscope slide and the capsules analysed. Alternatively, the capsule size may be measured during the preparation process, for example as the capsules are formed in a channel of a fluidic device (i.e. in line). In the preparation method described herein a capsule is prepared using a fluidic droplet generation technique. The capsule shell is formed in a droplet, which is created in a channel of a fluidic droplet generating device, at the boundary of the aqueous phase of the droplet with the continuous phase. The size of the capsule is therefore substantially the same as that of the droplet.

The present inventors have established that the capsules of the invention may be prepared with a low size distribution. This is particularly advantageous, as a large number of capsules may be prepared, each with predictable physical and chemical characteristics.

In one embodiment, the capsule diameter has a relative standard deviation (RSD) of at most 0.5%, at most 1%, at most 1.5%, at most 2%, at most 4%, at most 5%, at most 7%, at most 10%, at most 20%, or at most 30%.

The relative standard deviation is calculated from the standard deviation divided by the numerical average and multiplied by 100. The size of the capsule refers to the largest cross section of the capsule, in any section. The cross-section of a substantially spherical capsule is the diameter.

The shell defines an internal cavity which is suitable for encapsulating a component. The size of the internal space will generally correspond to the size of the capsule itself. Thus, the dimension, for example the diameter, of the internal space may be selected from any one of the diameter values given above for the shell itself.

Where the size of the capsule is measured, the diameter refers to the distance from the outermost edge to outmost edge of the shell material of two opposing points, as mentioned above. Where the size of the internal space is measured, the diameter refers to the distance from the innermost edge to innermost edge of the shell material of two opposing points

The inventors have established techniques that allow the shell outer and inner edges to be determined. For example, the presence of a detectable label within the shell material allows the outermost and innermost edges of the shell to be determined. If these edges can be detected, the thickness of the shell may be determined.

Typically, the diameter as measured from outermost to outermost edge is not significantly different to the diameter as measure from innermost to innermost edge. The difference is the thickness of the shell at the two opposing points.

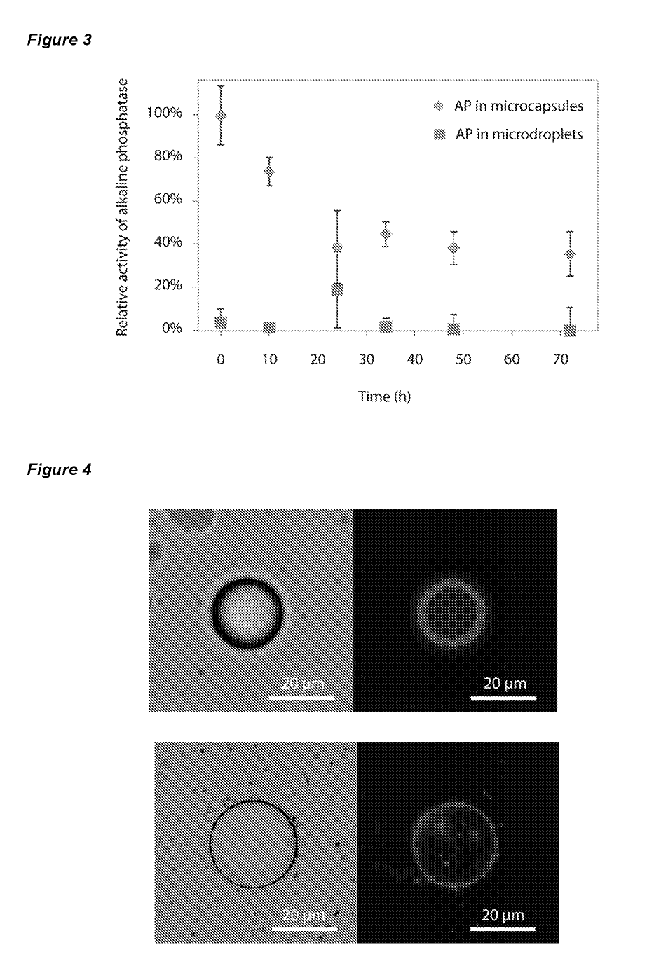

In one embodiment, the shell has a thickness of at most 0.02, at most 0.05, at most 0.1, at most 0.5, at most 1.0, at most 2.0 or at most 5.0 μm. Such thicknesses are mentioned in WO 2013/014452, and the worked examples show capsules having a thickness of around 1.0 or 2.0 μm (see FIG. 3 in that case).

The present invention provides capsules where the shell has a low amount of material, and is yet still capable of holding a catalyst, such as an enzyme within, and is capable of protecting the catalyst such that its catalytic activity is retained during the shell formation process and during storage.

As previously noted, the shell has pores. In one embodiment, the pores may be of a size to permit the passage of material therethrough. For example, reagents for reaction with an encapsulated catalyst may pass through the pores of the shell to enter the internal capsule space.

In one embodiment, the pores may be of a size that is too small to permit passage of material therethrough. For example, components encapsulated within the capsule may be prevented from passing through the pores of the shell, and therefore cannot be released from the capsule. Such material may be released from the capsule by, for example, disrupting the cucurbituril complexes that hold the shell together. Disruption of the shell in this way creates larger pores through which material may pass. In the present case, the pores are of sufficient size to prevent catalyst, such as an enzyme, from passing out of the capsule, and of sufficient size to allow reagents and product to pass into and out of the capsule, before and after a catalysis reaction.

As discussed above, the shell material may include detectable labels or detectable functionalities.

A detectable functionality is functionality of a capsule shell component having a characteristic that is detectable over and above the characteristics that are present in other components of the capsule, or even other functionalities of the same component. The detectable functionality may refer to a particular chemical group that gives rise to a unique signal in, for example, IR, UV-VIS, NMR or Raman analysis. The functionality may be a radioactive element.

Typically a part of the shell material or the encapsulant is provided with a detectable label, as the introduction of a chosen label allows the use of techniques that are most appropriate for the property that is to be measured. Described herein are building blocks having fluorescent detectable labels.

The shell may have additional functionality on its inner and/or outer surfaces. Described herein are building blocks having functionality to improve solubility, to aid detection, reactive functionality for later elaboration of the shell, and catalysts, amongst others.

The capsule shell of the invention is stable and may be stored without loss of the shell structure. The integrity of the shell therefore allows the capsule to be used as a storage vessel for an encapsulant. The capsules of the invention are thermally stable and the shell is known to maintain its integrity at least up to 100° C. The capsules of the invention are also stable at reduced pressures (i.e. below ambient pressure). The shell is known to maintain its integrity down to at least 20 Pa.

The capsules of the invention have a long shelf life. The present inventors have confirmed that structural integrity is maintained for at least 6 months or at least 10 months.

Advantageously, the capsules of the invention may be formulated into compositions, such as cleaning compositions, and may be stored within such compositions for at least 6 months or at least 10 months.

The structural integrity of the shell is in part due to the strength of the guest-host complex, such as the cucurbituril guest-host complex, which is described in more detail herein.

### Nested Capsules

Some of the present inventors have previously described the preparation of nested supramolecular capsules, where a first capsule is held within a second capsule, and each capsule has a shell of material that is a supramolecular cross-linked network. The shell of each capsule is obtainable from the complexation of a composition comprising a host and one or more building blocks having suitable host guest functionality thereby to form a supramolecular cross-linked network. This work is described in PCT/GB2014/050259, which is hereby incorporated by reference in its entirety.

A capsule as described above, such as a capsule holding a catalyst or a capsule having a small amount of shell material, may be a first or second capsule in a nested capsule.

A reference to a capsule is also a reference to a nested capsule.

### Complex

The capsule shell comprises a network that is held together by a supramolecular handcuff. The complex that forms this supramolecular handcuff is based on a host, such as cucurbituril, hosting one guest (binary complex) or two guests (ternary complex). The host, such as cucurbituril, forms a non-covalent bond to each guest. For example, the present inventors have established that complexes of cucurbituril are readily formed and provide robust non-covalent linkages between building blocks. The formation of the complex is tolerant of many functionalities within the building blocks. One of the present inventors has demonstrated that polymer networks may be prepared using a cucurbituril handcuff.

In one embodiment, the shell is a network having a plurality of complexes, wherein each complex comprises a host, such as cucurbituril, hosting a first guest molecule and a second guest molecule. The first and second guest molecules are covalently linked to a first building block, or to a first building block and a second building block.

Where the complex comprises two guests within the host cavity, the association constant, Kₐ, for that complex is at least 10³ M⁻², at least 10⁴ M⁻², at least 10⁵ M⁻², at least 10⁶ M⁻², at least 10⁷ M⁻², at least 10⁸ M⁻², at least 10⁹ M⁻², at least 10¹⁰ M⁻², at least 10¹¹ M⁻², or at least 10¹² M⁻².

Where a host, such as cucurbituril, hosts two guest molecules, the guest molecules may be the same or they may be different. A host that is capable of hosting two guest molecules may also be capable of forming a stable binary complex with a single guest. The formation of a ternary guest-host complex is believed to proceed via an intermediate binary complex. Within the shell, there may be present a binary complex formed between a guest molecule and a cucurbituril. The binary complex may be regarded as a partially formed ternary complex that has not yet formed a non-covalent bond to another guest molecule.

In one embodiment, the shell is a network having a plurality of complexes, wherein each complex comprises a host, such as cucurbituril, hosting one guest molecule, and each host is covalently linked to at least one other host. The guest molecules are covalently linked to a first building block, or to a first building block and a second building block.

Where the complex comprises one guest within the host cavity, the association constant, Kₐ, for that complex is at least 10³ M⁻¹, of at least 10⁴ M⁻¹, of at least 10⁵ M⁻¹, of at least 10⁶ M⁻¹, of at least 10⁷ M⁻¹, of at least 10⁸ M⁻¹, of at least 10⁹ M⁻¹, of at least 10¹⁰ M⁻¹, of at least 10¹¹ M⁻¹, or of at least 10¹² M⁻¹.

In one embodiment, the guest is a compound capable of forming a complex which has an association constant in the range 10⁴ to 10⁷ M⁻¹.

In one embodiment the formation of the complex is reversible. The decomplexation of the complex to separate the guest or guests may occur in response to an external stimulus, including, for example, a competitor guest compound. Such decomplexation may be induced in order to provide additional or larger pores in the capsule through which an encapsulated material may pass.

As noted above in relation to the capsule shell, the complex of cucurbituril with one or two guests is the non-covalent link that links and/or interlinks the building blocks to from a supramolecular network of material. The complex is thermally stable and does not separate at reduced pressure, as explained for the shell.

### Component

In one aspect of the invention there is provided a capsule encapsulating a component. In one embodiment, the capsule has a shell with low amounts of material relative to the amount of encapsulated component, for example where the component is present at 60 wt % or more, such as 70, 80, 85, 90 or 95 wt % or more, as a percentage of the total amount of component and the capsule shell.

In another embodiment, the component is present in the capsule at a high concentration. This is described in further detail below. The concentration of the component in the capsule may be the concentration of the component in the fluid flow that is used to prepare the capsule in the methods described herein.

The component may be a catalyst, and such may find use in the methods of catalysis described herein.

It is understood that a reference to an encapsulated component is not a reference to a solvent molecule. For example, the encapsulated component is not water or is not an oil or an organic solvent. It is also understood that a reference to an encapsulated component is not a reference to a host, such as cucurbituril, or a building block for use in the preparation of the capsule shell. Otherwise, the component is not particularly limited.

The encapsulant is therefore a component of the capsule that is provided in addition to solvent that may be present within the shell.

In the methods of the invention the capsule shell is prepared from a composition comprising a cucurbituril (or another host) and one or more building blocks, as appropriate. Not all the cucurbituril and one or more building blocks may react to form shell material. Additionally, the cucurbituril and one or more building blocks may react to form a network, but this network may be not be included in the shell that forms the capsule. These unreacted or partially reacted reagents and products may be contained within the shell, and may be contained in addition to the encapsulant. Thus, the encapsulant is a component of the capsule that is provided in addition to unreacted or partially reacted reagents and products that may be present within the shell.

In one embodiment, the encapsulant is a therapeutic compound.

In one embodiment, the encapsulant is a biological molecule, such as a polynucleotide (for example DNA and RNA), a polypeptide or a polysaccharide.

In one embodiment, the encapsulant is a polymeric molecule, including biological polymers such as those polymers mentioned above.

In one embodiment, the encapsulant is a cell.

In one embodiment, the encapsulant is an ink.

In one embodiment, the encapsulant is a carbon nanotube.

In one embodiment, the encapsulant is a particle. The particle may be a metal particle.

The size of the capsule is selected so as to accommodate the size of the encapsulant. Thus, the internal diameter (the distance from innermost wall to innermost wall) is greater than the greatest dimension of the encapsulant.

In one embodiment, the encapsulant has a detectable label. The detectable label may be used to quantify and/or locate the encapsulant. The label may be used to determine the amount of encapsulant contained with the capsule.

In one embodiment, the detectable label is a luminescent label. In one embodiment, the detectable label is a fluorescent label or a phosphorescent label.

In one embodiment, the detectable label is a visible.

In one embodiment, the fluorescent label is a rhodamine or fluorescein label.

As noted above, the component may be present at 60 wt % or more as a percentage of the total mass of the capsule.

It is possible to determine the wt % of a capsule from the concentration of the component, the host and the building blocks in the fluids that are used to prepare the capsules using the fluidic techniques described herein.

Typically a capsule shell is prepared at the boundary of a dispersed second phase (such as a droplet) in a continuous first phase. The reagents for forming the capsule shell may be provided in a flow of a second phase which is dispersed in the first phase. The component to be encapsulated is also provided in the second flow, and the formation of the shell serves to encapsulate the component.

The concentration of the reagents and the component in the second fluid flow, will therefore also be the concentration of those reagents in the dispersed second phase. Here it is a reasonable assumption that the component and the reagent will not pass into the immiscible first phase.

The size and the volume of the dispersed regions of the second phase are easily determined. For example, it is typical to form spherical droplets of the second phase in the first phase. The diameter of the droplet may be determined form microscopy images (as shown herein) and the volume of the droplet may be calculated accordingly, on the assumption that the droplet is a perfect sphere. This is also a reasonable assumption given the observed morphology of the capsule s prepared in the present case.

With the volume of the droplet known, and the concentration of reagents and component known, it is possible to determine the mass amount of the component and the shell materials. Thus, the calculate wt % is the mass of component in a droplet as a percentage of the total mass of the capsule, which includes the mass of the shell reagents and the mass of component.

It is assumed that all the shell reagents participate in the formation of the shell. This is believed to be a reasonable assumption, and the location of reagents after capsule collection is at the shell boundary rather than a dispersion across the internal space of the capsule.

The wt % calculations relate only to the component content with respect to the shell content. For the purpose of determining the wt % the solvent content of the capsule is ignored. Thus, the wt % is an indication of the component loading of the capsule.

### Catalyst

The present case provides a method of catalysis. A catalyst is permitted to catalyse the reaction of a reagent to yield a product. The catalyst in provided within a capsule and the capsule has a shell of material that is a supramolecular cross-linked network. The present application also relates to a capsule holding a catalyst at relatively high concentration (loading). The inventors have found that the activity of the catalyst is maintained, and the catalyst may be used as such within the capsule or it may be released as required.

The catalyst is a catalyst for the reaction of the reagent. The catalyst is permitted to contact the reagent within the capsule.

In one embodiment, the catalyst is a polypeptide.

In one embodiment, the catalyst is an enzyme. The worked examples in the present case demonstrate that an encapsulated enzyme, such as an α-amylase or an alkaline phosphatase, may participate as a catalyst in a reaction whilst the enzyme is encapsulated in a capsule.

In one embodiment, the catalyst is a metal-containing particle.

In one embodiment, the catalyst is selected from the group consisting of protease, amylase, mannanase, and cellulase enzymes. Such enzymes are suitable for use in cleaning compositions as described herein.

### Cucurbituril

The present invention provides use of cucurbituril as a supramolecular handcuff to link and/or crosslink building blocks. The cucurbituril may be used to form ternary complexes with first and second guest molecules present on one or more building blocks. The formation of such complexes links individual building blocks thereby to form a network of material. This network is the shell of the capsule.

Additionally, or alternatively, a plurality of covalently linked cucurbiturils is provided and each cucurbituril may be used to form binary complexes with a guest molecule present on one or more building blocks. The formation of a binary complex with each of the covalently linked cucurbiturils thereby forms a network of material. This network is the shell of the capsule.

In one embodiment, the cucurbituril is capable of forming a ternary complex. For example, CB[8], is capable of forming a ternary complex.

In one embodiment, the cucurbituril is capable of forming a binary complex. For example, CB[7], is capable of forming a binary complex.

In one embodiment, the cucurbituril is capable of forming ternary and binary complexes.

For example, CB[8], is capable of forming a ternary or a binary complex, depending upon the nature of the guest.

In one embodiment, the cucurbituril is a CB[5], CB[6], CB[7], CB[8], CB[9], CB[10], CB[11] or CB[12] compound.

In one embodiment, the cucurbituril is a CB[6], CB[7], or CB[8] compound.

In one embodiment, the cucurbituril is a CB[8] compound.

In one embodiment, references to a cucurbituril compound are references to variants and derivatives thereof.

Cucurbituril compounds differ in their water solubility. The methods of capsule preparation may be adapted to take into account this solubility, as described later. Therefore the choice of cucurbituril compound is not limited by its aqueous solubility.

In one embodiment, the cucurbituril compound has a solubility of at least 0.01 mg/mL, at least 0.02 mg/mL, at least 0.05 mg/mL, or at least 0.10 mg/mL.

In one embodiment, the solubility refers to aqueous solubility (i.e. an aqueous phase).

In one embodiment, the solubility refers to solubility in a water immiscible phase, such as an oil phase or an organic phase.

Cucurbit[8]uril (CB[8]; CAS 259886-51-6) is a barrel shaped container molecule which has eight repeat glycoluril units and an internal cavity size of 479 A³ (see structure below). CB[8] is readily synthesised using standard techniques and is available commercially (e.g. Sigma-Aldrich, MO USA).

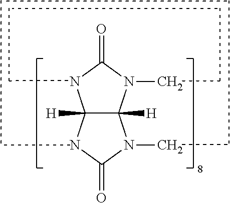

In other aspects of the invention, CB[8] variants are provided and find use in the methods described herein.

A variant of CB[8] may include a structure having one or more repeat units that are structurally analogous to glycoluril. The repeat unit may include an ethylurea unit. Where all the units are ethylurea units, the variant is a hemicucurbituril. The variant may be a hemicucurbit[12]uril (shown below, see also Lagona et al. Angew. Chem. Int. Ed. 2005, 44, 4844).

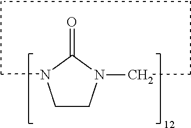

In other aspects of the invention, cucurbituril derivatives are provided and find use in the methods described herein. A derivative of a cucurbituril is a structure having one, two, three, four or more substituted glycoluril units. A substituted cucurbituril compound may be represented by the structure below:

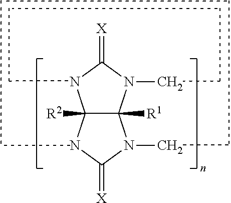

wherein:
n is an integer of at least 5;
and for each glycoluril unit
each X is O, S or NR³, and
—R¹ and —R² are each independently selected from —H and the following optionally substituted groups: —R³, —OH, —OR³, —COOH, —COOR³, —NH₂, —NHR³ and —N(R³)₂ where —R³ is independently selected from C₁₋₂₀alkyl, C₆₋₂₀carboaryl, and C₆₋₂₀heteroaryl, or where —R¹ and/or —R² is —N(R³)₂, both —R³ together form a C₅₋₇ heterocyclic ring; or together —R¹ and —R² are C₄₋₆alkylene forming a C₆₋₈carbocyclic ring together with the uracil frame.

In one embodiment, one of the glycoluril units is a substituted glycoluril unit. Thus, —R¹ and —R² are each independently —H for n−1 of the glycoluril units

In one embodiment, n is 5, 6, 7, 8, 9, 10, 11 or 12.

In one embodiment, n is 5, 6, 7, 8, 10 or 12.

In one embodiment, n is 8.

In one embodiment, each X is O.

In one embodiment, each X is S.

In one embodiment, R¹ and R² are each independently H.

In one embodiment, for each unit one of R¹ and R² is H and the other is independently selected from —H and the following optionally substituted groups: —R³, —OH, —OR³, —COOH, —COOR³, —NH₂, —NHR³ and —N(R³)₂. In one embodiment, for one unit one of R¹ and R² is H and the other is independently selected from —H and the following optionally substituted groups: —R³, —OH, —OR³, —COOH, —COOR³, —NH₂, —NHR³ and —N(R³)₂. In this embodiment, the remaining glycoluril units are such that R¹ and R² are each independently H.

Preferably —R³ is C₁₋₂₀alkyl, most preferably C₁₋₆alkyl. The C₁₋₂₀alkyl group may be linear and/or saturated. Each group —R³ may be independently unsubstituted or substituted. Preferred substituents are selected from: —R⁴, —OH, —SH, —SR⁴, —COOH, —COOR⁴, —NH₂, —NHR⁴ and —N(R⁴)₂, wherein —R⁴ is selected from C₁₋₂₀alkyl, C₆₋₂₀carboaryl, and C₅₋₂₀heteroaryl. The substituents may be independently selected from —COOH and —COOR⁴.

In some embodiments, —R⁴ is not the same as —R³. In some embodiments, —R⁴ is preferably unsubstituted.

Where —R¹ and/or —R² is —OR³, —NHR³ or —N(R³)₂, then —R³ is preferably C₁₋₆alkyl. In some embodiments, —R³ is substituted with a substituent —NHR⁴ or —N(R⁴)₂. Each —R⁴ is C₁₋₆alkyl and is itself preferably substituted.

In some embodiments of the invention there is provided the use of a plurality of covalently linked cucurbiturils. Such covalently linked cucurbiturils are suitable for forming networks based on the complexation of the cucurbituril with guest molecules of a building block. The complexes formed may be ternary or binary complexes.

A cucurbituril may be covalently linked to another cucurbituril via a linker group that is a substituent at position R¹ or R² at one of the glycoluril units in the cucurbituril as represented in the structure shown above. There are no particular limitations on the covalent link between the cucurbiturils. The linker may be in the form of a simple alkylene group, a polyoxyalkylene group or a polymer, such as a polymeric molecule described herein for use in the building block. Where the linker is a polymeric molecule, the cucurbiturils may be pendant to that polymer.

### Cucurbituril Guest

As noted above, the guest is a compound that is capable of forming a guest-host complex with a host, such as a cucurbituril. The term complexation therefore refers to the establishment of the guest-host complex.

In some embodiments of the invention, the guest host complex is a ternary complex comprising the cucurbituril host and a first guest molecule and a second molecule. Typically such complexes are based around CB[8] and variants and derivatives thereof.

In some embodiments of the invention, the guest host complex is a binary complex comprising the cucurbituril host and a first guest molecule. Typically such complexes are based around CB[5] or CB[7], and variants and derivatives thereof. In the present invention, binary complexes are obtainable from a plurality of covalently linked cucurbiturils. CB[8], and variants and derivatives thereof, may also form binary complexes.

In principal, any compound having a suitable binding affinity may be used in the methods of the present invention. The compound used may be selected based on the size of the moieties that are thought to interact with the cavity of the cucurbituril. The size of these moieties may be sufficiently large to permit complexation only with larger cucurbituril forms.

The term selective may be used to refer to the amount of guest-host complex formed. where the cucurbituril (the first cucurbituril) and a second cucurbituril are present in a mixture with a particular guest molecule or guest molecules. The guest-host complex formed between the first cucurbituril and the guest (in a binary complex) or guests (in a ternary complex) may be at least 60 mol %, at least 70 mol %, at least 80 mol %, at least 90 mol %, at least 95 mol %, at least 97 mol %, at least 98 mol %, or at least 99 mol %, of the total amount of guest-host complex formed (for, example taking into account the amount of guest-host complex formed between the second cucurbituril and the guest or guests, if any).

In one embodiment, the guest-host complex formed from the (first) cucurbituril and the guest or guests has a binding affinity that is at least 100 times greater than the binding affinity of a guest host complex formed from the second cucurbituril and the guest or guests. Preferably, the binding affinity is at least 10³, at least 10⁴, at least 10⁵, at least 10⁶, or at least 10⁷ greater.

Cucurbituril guest molecules are well known in the art. Examples of guest compounds for use include those described in WO 2009/071899, Jiao et al. (Jiao et al. Org. Lett. 2011, 13, 3044), Jiao et al. (Jiao et al. J. Am. Chem. Soc. 2010, 132, 15734) and Rauwald et al. (Rauwald et al. J. Phys. Chem. 2010, 114, 8606).

Described below are guest molecules that are suitable for use in the formation of a capsule shell. Such guest molecules may be connected to a building block using standard synthetic techniques.

A cucurbituril guest molecule may be derived from, or contain, a structure from the table below:

Guest Molecules

| | |
|---|---|
| A1 | 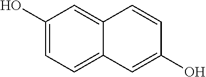 [SMILES: Oc1ccc2cc(O)ccc2c1] |
| A2 | 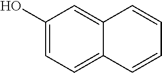 [SMILES: Oc1ccc2ccccc2c1] |
| A3 | 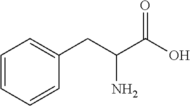 [SMILES: NC(Cc1ccccc1)C(=O)O] |
| A4 | 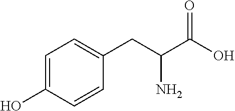 [SMILES: NC(Cc1ccc(O)cc1)C(=O)O] |
| A5 | 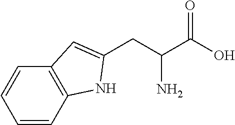 [SMILES: NC(Cc1cc2ccccc2[nH]1)C(=O)O] |
| B1 | 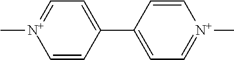 |
| A6 | 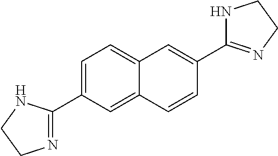 [SMILES: c1cc2cc(C3=NCCN3)ccc2cc1C1=NCCN1] |
| A7 | 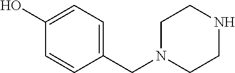 [SMILES: Oc1ccc(CN2CCNCC2)cc1] |
| A8 | 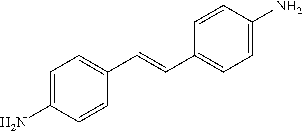 [SMILES: Nc1ccc(/C=C/c2ccc(N)cc2)cc1] |
| A9 | 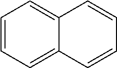 |
| A10 | 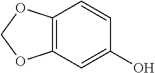 |
| A11 | 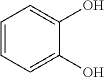 |
| A12 | 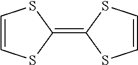 |
| B2 | 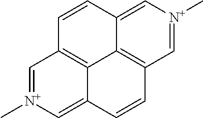 |
| B3 | 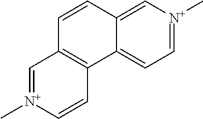 |
| B4 | 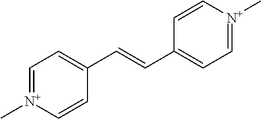 |
| A13 | 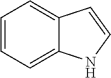 |
| A14 | 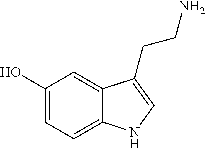 [SMILES: NCCc1c[nH]c2ccc(O)cc12] |
| A15 | 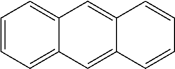 [SMILES: c1ccc2cc3ccccc3cc2c1] |
| A16 | 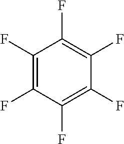 [SMILES: Fc1c(F)c(F)c(F)c(F)c1F] |
| A17 | 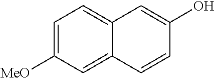 [SMILES: COc1ccc2cc(O)ccc2c1] |
| A18 | 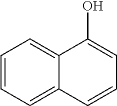 [SMILES: Oc1cccc2ccccc12] |
| A19 | 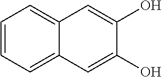 [SMILES: Oc1cc2ccccc2cc1O] |
| A20 | 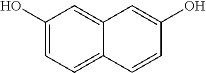 [SMILES: Oc1ccc2ccc(O)cc2c1] |
| A21 | 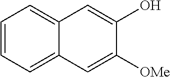 [SMILES: COc1cc2ccccc2cc1O] |
| A22 | 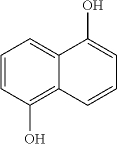 [SMILES: Oc1cccc2c(O)cccc12] |
| A23 | 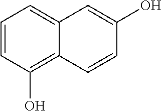 [SMILES: Oc1ccc2c(O)cccc2c1] |
| A24 | 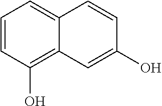 [SMILES: Oc1ccc2cccc(O)c2c1] |
| A25 | 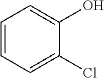 |
| A26 | 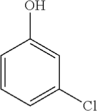 |
| A27 | 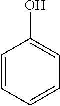 |
| A28 | 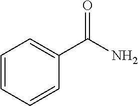 |
| A29 | 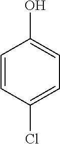 |
| A30 | 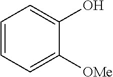 |
| A31 | 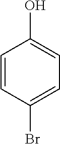 |
| A32 | 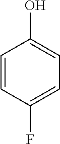 |
| A33 | 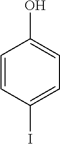 |
| A34 | 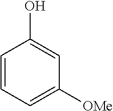 |
| A35 | 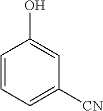 |
| A36 | 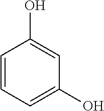 |
| A37 | 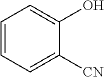 |
| A38 | 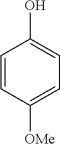 |
| A39 | 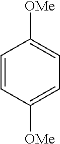 |
| A40 | 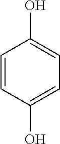 |
| A41 | 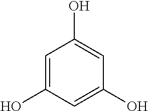 |
| A42 | 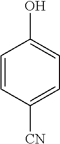 |
| A43 | 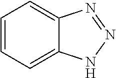 |
| A44 | 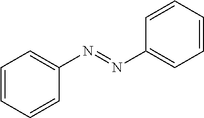 [SMILES: c1ccc(/N=N/c2ccccc2)cc1] |
| A45 | 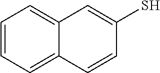 [SMILES: Sc1ccc2ccccc2c1] |
| A46 | 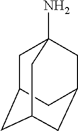 [SMILES: NC12CC3CC(CC(C3)C1)C2] |

where the structure may be a salt, including protonated forms, where appropriate. In one embodiment, the guest molecules are guest molecules for CB[8].

In one embodiment, the guest molecule is, or is derived from, or contains, structure A1-A43, A46 or B1-B4, in the table above.

In one embodiment, the guest molecule is, or is derived from, or contains, structure A1, A2, or A13 in the table above.

In one embodiment, the guest molecule is, or is derived from, or contains, structure B1.

Additionally, the guest molecule is or is derived from, or contains, adamantane, ferrocene or cyclooctane (including bicyclo[2.2.2]octane). Such are described by Moghaddam et al. (see J. Am. Chem. Soc. 2011, 133, 3570).

In some embodiments, first and second guest molecules form a pair which may interact within the cavity of cucurbituril to form a stable ternary host-guest complex. Any guest pair that fits within the cavity of the cucurbituril may be employed. In some embodiments, the pair of guest molecules may form a charge transfer pair comprising an electron-rich and an electron-deficient compound. One of the first and second guest molecules acts as an electron acceptor and the other as an electron donor in the CT pair. For example, the first guest molecule may be an electron deficient molecule which acts an electron acceptor and the second guest molecule may be an electron rich molecule which acts as an electron donor or vice versa. In one embodiment, the cucurbituril is CB[8].

Suitable electron acceptors include 4,4′-bipyridinium derivatives, for example N,N′-dimethyldipyridyliumylethylene, and other related acceptors, such as those based on diazapyrenes and diazaphenanthrenes. Viologen compounds including alkyl viologens are particularly suitable for use in the present invention. Examples of alkyl viologen compounds include N,N′-dimethyl-4,4′-bipyridinium salts (also known as Paraquat).

Suitable electron donors include electron-rich aromatic molecules, for example 1,2-dihydroxybenzene, 1,3-dihydroxybenzene, 1,4-dihydroxybenzene, tetrathiafulvalene, naphthalenes such as 2,6-dihydroxynaphthalene and 2-naphthol, indoles and sesamol (3,4-methylenedioxyphenol). Polycyclic aromatic compounds in general may find use as suitable electron donors in the present invention. Examples of such compounds include anthracene and naphthacene.

Amino acids, such as tryptophan, tyrosine and phenylalanine may be suitable for use as electron donors. Peptide sequences comprising these amino acids at their terminus may be used. For example, a donor comprising an amino acid sequence N-WGG-C, N-GGW-C or N-GWG-C may be used.

In some embodiments, the guest molecules are a pair of compounds, for example first and second guest molecules, where one of the pair is an A compound as set out in the table above (e.g. A1, A2, A3 etc.), and the other of the pair is a B compound as set out in the table above (e.g. B1, B2, B3 etc.). In one embodiment, the A compound is selected from A1-A43 and A46. In one embodiment, the B compound is B1.

Other suitable guest molecules include peptides such as WGG (Bush, M. E. et al J. Am. Chem. Soc. 2005, 127, 14511-14517).

An electron-rich guest molecule may be paired up with any electron-deficient CB[8] guest molecule. Examples of suitable pairs of guest molecules for example first and second guest molecules, for use as described herein may include:
viologen and naphthol;
viologen and dihydroxybenzene;
viologen and tetrathiafulvalene;
viologen and indole;
methylviologen and naphthol;
methylviologen and dihydroxybenzene;
methylviologen and tetrathiafulvalene;
methylviologen and indole;
N,N′-dimethyldipyridyliumylethylene and naphthol;
N,N′-dimethyldipyridyliumylethylene and dihydroxybenzene;
N,N′-dimethyldipyridyliumylethylene and tetrathiafulvalene;
N,N′-dimethyldipyridyliumylethylene and indole;
2,7-dimethyldiazapyrenium and naphthol;
2,7-dimethyldiazapyrenium and dihydroxybenzene;
2,7-dimethyldiazapyrenium and tetrathiafulvalene; and
2,7-dimethyldiazapyrenium and indole.

In particular, suitable pairs of guest molecules for use as described herein may include 2-naphthol and methyl viologen, 2,6-dihydroxynaphthalene and methyl viologen and tetrathiafulvalene and methyl viologen.

In one embodiment, the guest pair is 2-naphthol and methyl viologen.

In one embodiment, the guest pair is a reference to a pair of guest molecules suitable for forming a ternary complex with CB[8].

In one embodiment, the guest molecule is preferably an ionic liquid. Typically, such guests are suitable for forming a complex with CB[7]. However, they may also form complexes with CB[8] in either a binary complex, or in a ternary complex together with another small guest molecule or solvent (see Jiao et al. Org. Left. 2011, 13, 3044).

The ionic liquid typically comprises a cationic organic nitrogen heterocycle, which may be an aromatic nitrogen heterocycle (a heteroaryl) or a non-aromatic nitrogen heterocycle. The ionic liquid also typically comprises a counter-anion to the cationic organic nitrogen heterocycle. The nitrogen heteroaryl group is preferably a nitrogen C₅₋₁₀heteroaryl group, most preferably a nitrogen C₅₋₆heteroaryl group, where the subscript refers to the total number of atoms in the ring or rings, including carbon and nitrogen atoms. The non-aromatic nitrogen heterocycle is preferably a nitrogen C₅₋₆heterocycle, where the subscript refers to the total number of atoms in the ring or rings, including carbon and nitrogen atoms. A nitrogen atom in the ring of the nitrogen heterocycle is quaternised.

The counter-anion may be a halide, preferably a bromide. Other counter-anions suitable for use are those that result in a complex that is soluble in water.

The guest is preferably a compound, including a salt, comprising one of the following groups selected from the list consisting of: imidazolium moiety; pyridinium moiety; quinolinium moiety; pyrimidinium moiety; pyrrolium moiety; and quaternary pyrrolidine moiety.

Preferably, the guest comprises an imidazolium moiety. An especially preferred guest is 1-alkyl-3-alkylimidazolium, where the alkyl groups are optionally substituted.

1-Alkyl-3-alkylimidazolium compounds, where the alkyl groups are unsubstituted, are especially suitable for forming a complex with CB[7].

1-Alkyl-3-alkylimidazolium compounds, where the alkyl groups are unsubstituted, are especially suitable for forming a complex with CB[6]

1-Alkyl-3-alkylimidazolium compounds, where an alkyl group is substituted with aryl (preferably napthyl), are especially suitable for forming a complex with CB[8].

The 1-alkyl and 3-alkyl substituents may the same or different. Preferably, they are different.

In one embodiment, the 3-alkyl substituent is methyl, and is preferably unsubstituted. In one embodiment, the 1-alkyl substituent is ethyl or butyl, and each is preferably unsubstituted.

In one embodiment, the optional substituent is aryl, preferably C₅₋₁₀aryl. Aryl includes carboaryl and heteroaryl. Aryl groups include phenyl, napthyl and quinolinyl.

In one embodiment, the alkyl groups described herein are linear alkyl groups. Each alkyl group is independently a C₁₋₆alkyl group, preferably a C₁₋₄alkyl group.

The aryl substituent may itself be another 1-alkyl-3-substituted-imidazolium moiety (where the alkyl group is attached to the 3-position of the ring).

In another embodiment, the compound preferably comprises a pyridinium moiety.

The ionic liquid molecules describe above are particular useful for forming binary guest-host complexes. Complexes comprising two ionic liquid molecules as guests within a cucurbituril host are also encompassed by the present invention.

A cucurbituril may be capable of forming both binary and ternary complexes. For example, it has been previously noted that CB[6] compounds form ternary complexes with short chain 1-alkyl-3-methylimidazolium guest molecules, whilst longer chain 1-alkyl-3-methylimidazolium guest molecules form binary complexes with the cucurbituril host.

Preferred guests for use in the present invention are of the form H⁺X⁻, where H⁺ is one of the following cations,

| Cation | Structure |
|---|---|
| A | 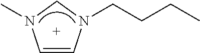 |
| B | 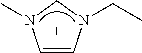 |
| C | 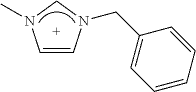 |
| D | 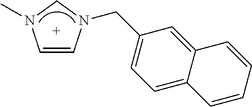 [SMILES: CN1C=CN(Cc2ccc3ccccc3c2)C1] |
| E | 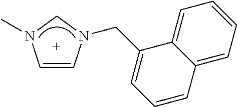 [SMILES: CN1C=CN(Cc2cccc3ccccc23)C1] |
| F | 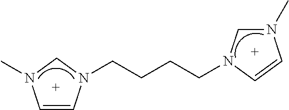 |
| G | 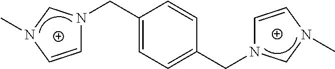 |
| H | 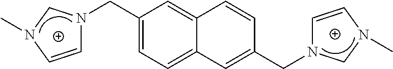 |
| I | 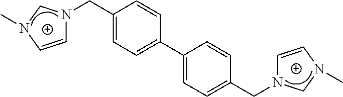 |

and X⁻ is a suitable counter-anion, as defined above. A preferred counter anion is a halide anion, preferably BC.

In a preferred embodiment, cation A or cation B may be used to form a complex with CB[7] or CB[6].

In a preferred embodiment, cation D or cation E may be used to form a complex with CB[8].

Cations A and B may be referred to as 1-ethyl-3-methylimidazolium and 1-butyl-3-methylimidazolium respectively.

Cations D and E may be referred to as 1-naphthalenylmethyl-3-methylimidazolium, where D is 1-naphthalen-2-ylmethyl-3-methylimidazolium and E is 1-naphthalen-1-ylmethyl-3-methylimidazolium.

Alternatively or additionally, the guest compounds may be an imidazolium salt of formula (I):

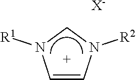

wherein X⁻ is a counter anion;
R¹ is independently selected from H and saturated C₁₋₆ alkyl;
R² is independently C₁₋₁₀ alkyl which may optionally contain one or more double or triple bonds, and may be optionally interrupted by a heteroatom selected from —O—, —S—, —NH—, and —B—, and may be optionally substituted.

In one embodiment, X⁻ is independently selected from the group consisting of Cl⁻, Br⁻, I⁻, BF₄⁻, PF₆⁻, OH⁻, SH⁻, HSO₄⁻, HCO₃⁻, NTf₂, C₂N₅O₄, AlCl₄⁻, Fe₃Cl₁₂, NO₃⁻, NMeS₂⁻, MeSO₃⁻, SbF₆⁻, PrCB₁₁H₁₁⁻, AuCl₄⁻, HF₂⁻, NO₂⁻, Ag(CN)₂⁻, and NiCl₄⁻. In one embodiment, X⁻ is selected from Cl⁻, Br, and I⁻.

In one embodiment, R¹ is selected from H and linear saturated C₁₋₆ alkyl.

In one embodiment, R² is linear C₁₋₁₀ alkyl, which may optionally contain one or more double bonds, and may be optionally interrupted by a heteroatom selected from —O—, —S—, —NH—, and —B—, and may be optionally substituted.

In one embodiment, R² is linear C₁₋₁₀ alkyl, which may optionally contain one or more double bonds, and may be optionally substituted.

In one embodiment, where a double or triple bond is present, it may be conjugated to the imidazolium moiety. Alternatively, the double or triple bond may not be conjugated to the imidazolium moiety.

In one embodiment, the optional substituents are independently selected from the group consisting of halo, optionally substituted C₅₋₂₀ aryl, —OR³, —OCOR³, ═O, —SR³, ═S, —BR³, —NR³R⁴, —NR³COR³, —N(R³)CONR³R⁴, —COOR³, —C(O)R³, —C(═O)SR³, —CONR³R⁴, —C(S)R³, —C(═S)SR³, and —C(═S)NR³R⁴,
where each of R³ and R⁴ is independently selected from H and optionally substituted saturated C₁₋₆ alkyl, C₅₋₂₀ aryl and C₁₋₆ alkylene-C₅₋₂₀ aryl.
or R³ and R⁴ may together may form an optionally saturated 5-, 6- or 7-membered heterocyclic ring which is optionally substituted with a group —R³.

In one embodiment, the optional substituents are independently selected from the group consisting of halo, optionally substituted C₅₋₂₀ aryl, —OR³, —OCOR³, —NR³R⁴, —NR³COR³, —N(R³)CONR³R⁴, —COOR³, —C(O)R³, and —CONR³R⁴, where R³ and R⁴ are defined as above.

Each C₅₋₂₀ aryl group may be independently selected from a C₆₋₂₀ carboaryl group or a C₅₋₂₀ heteroaryl group.

Examples of C₆₋₂₀ carboaryl groups include phenyl and napthyl.

Examples of C₅₋₂₀ heteroaryl groups include pyrrole (azole) (C₅), pyridine (azine) (C₆), furan (oxole) (C₅), thiophene (thiole) (C₅), oxazole (C₅), thiazole (C₅), imidazole (1,3-diazole) (C₅), pyrazole (1,2-diazole) (C₅), pyridazine (1,2-diazine) (C₆), and pyrimidine (1,3-diazine) (C₆) (e.g., cytosine, thymine, uracil).

Each C₅₋₂₀ aryl is preferably selected from optionally substituted phenyl, napthyl and imidazolium.

Each C₅₋₂₀ aryl group is optionally substituted. The optional substituents are independently selected from halo, C₁₋₆ alkyl, —OR³, —OCOR³, —NR³R⁴, —NR³COR³, —N(R³)CONR³R⁴, —COOR³, —C(O)R³, and —CONR³R⁴, where R³ and R⁴ are defined as above.

In one embodiment, each C₅₋₂₀ aryl group is optionally substituted with C₁₋₆ alkyl.

Where the C₅₋₂₀ aryl group is an imidazolium, such is preferably substituted at nitrogen with a group R¹ (thereby forming a quaternary nitrogen).

The compound of formula (I) comprises an imidazolium moiety having a substituent R² at the 1-position and a substituent R¹ at the 3-position. In a further aspect of the invention, the compound of formula (I) may be optionally further substituted at the 2-, 4- or 5-position with a group R^{A}, wherein R^{A} has the same meaning as R¹.

The embodiments above are combinable in any combination, as appropriate.

### Building Block

Cucurbituril is used as a supramolecular handcuff to join together one or more building blocks. The formation of a complex of the host, such as cucurbituril, with suitable guest components that are linked to the building blocks forms a network of material. This material is the capsule shell. The complex non-covalently crosslinks the building block or non-covalently links the building block to another building block.

It is understood from the above that a building bock is an entity that serves to provide structure to the formed network. The building block also serves as the link between a plurality of guest molecules, and it may therefore also be referred to as a linker. In some embodiments, a building block is provided for the purpose of introducing a desirable physical or chemical characteristic into the formed network. As mentioned above in relation to the network, a building block may include a functionality to aid detection and characterisation of the shell. Such building blocks need not necessarily participate in a crosslink.

A building block, such as a first building block, may be covalently linked to a plurality of cucurbituril guest molecules. A building block will therefore non-covalently link to a plurality of hosts, such as cucurbiturils, which hosts will non-covalently link to other building blocks, thereby to generate a network of material.

A building block, such as a first building block or a second building block, may be covalently linked to a plurality of guest molecules. In one embodiment, a building block is covalently linked to at least 3, at least 4, at least 5, at least 10, at least 20, at least 50, at least 100, at least 500, at least 1,000, at least 2,000, at least 5,000 or at least 10,000 cucurbituril guest molecules.

In certain embodiments, building blocks covalently linked to one or more guest molecules may be used. However, such building blocks are used only in combination with other building blocks that are covalently linked to at least two guest molecules.

In one embodiment, there is provided a first building block covalently linked to a plurality of first guest molecules and a second building block covalently linked to a plurality of second guest molecules. Each of the first and second building blocks may be covalently linked to at least the number of guest molecules described above.

In one embodiment, there is provided a first building block covalently linked to a plurality of first guest molecules and covalently linked to a plurality of second guest molecules. The first building block may be covalently linked to at least the number of guest molecules described above, which numbers may refer independently to the number of first guest molecules and the number of second guest molecules.

In one embodiment, there is provided a second building block covalently linked to one or more third guest molecules and/or covalently linked to a one or more fourth guest molecules. In one embodiment, the second building block is covalently linked to at least the number of guest molecules described above, which numbers may refer independently to the number of third guest molecules and the number of fourth guest molecules. Such a second building block may be used together with the first building block described in the paragraph above.

Throughout the description, references are made to first and second building blocks. In some embodiments, the first and second building blocks may be distinguished from each other owing to differences, at least, in the structure of the building blocks themselves. In some embodiments, the structures of the first and second building blocks are the same. In this case, the building blocks may be distinguished from each other owing to differences, at least, in the guest molecules that are covalently linked to each of the first and the second guest molecules. Thus the terms first and second are intended to convey a difference between the first building block together with its guest molecules and the second building block together with its guest molecules.

The building blocks are not particularly limited, and the building block includes compounds and particles, and may encompass assemblies of either of these. The guest molecules are covalently linked to some portion of the building block.

At its simplest a building block is a linker for the connection of guest molecules. In one embodiment the building block is a polymeric molecule or a particle.

Advantageously, a building block may be provided with certain functionality to aid the formation of the capsule shell, or to improve its physical or chemical properties. In one embodiment, the building block is provided with functionality to alter, or preferably improve, water solubility. The functionality may take the form of a solubilising group, such as a group comprising polyethylene glycol functionality. Other examples include groups comprising amino, hydroxy, thiol, and carboxy functionality.

In one embodiment, the building block is provided with functionality to aid detection or analysis of the building block, and to aid detection or analysis of the formed shell. Advantageously, such functionality may also aid the detection of material encapsulated within the shell. The functionality may take the form of a detectable label, such as a fluorescent label.

In one embodiment, the building block is provided with reactive functionality for use in the later elaboration of the shell material. The reactive functionality may be protected for the shell forming reactions, then later deprotected to reveal the functionality. The functionality may be a group comprising amino, hydroxy, thiol, and carboxy functionality.

Where the building block is provided with reactive functionality is provided, this functionality may be suitable for linking the building block (and therefore the formed capsule) to a surface.

Where functionality is provided it may be located at the outer side of, the inner side of and/or within the shell. Thus, the functionality may be provided in connection with the improvements related to the environment out with the shell, within the internal space (the space for holding an encapsulant) of the shell and/or within the shell (within the network of shell material).

A building block is linked to a cucurbituril guest molecule or guest molecules by covalent bonds. The covalent bond may be a carbon-carbon bond, a carbon-nitrogen bond, a carbon-oxygen bond. The bond may be part of a linking group such as an ester or an amide, and/or part of a group comprising an alkylene or alkoxylene functionality.

Each guest molecule may be linked to the building block using routine chemical linkage techniques. For example, guest molecules may be linked to the building block by: alkylation of a building block bearing an appropriate leaving group; esterification reactions; amidation reactions; ether forming reactions; olefin cross metathesis; or small guest molecule initiated reactions in which a polymer chain is grown off an initiating guest molecule.

In one embodiment, the average molecular weight of a building block, optionally together with any guest molecules, is at least 1,000, at least 5,000, at least 10,000, or at least 20,000. In one embodiment, the average molecular weight of a building block, optionally together with any guest molecules, is at most 30,000, at most 50,000, at most 100,000, at most 200,000, at most 500,000, at most 1,000,000, or at most 2,000,000.

The average molecular weight may refer to the number average molecular weight or weight average molecular weight.

In one embodiment, the average molecular weight of a building block is in a range where the minimum and maximum amounts are selected from the embodiments above. For example, the average molecular weight is in the range 1,000 to 100,000.

In one embodiment, a building block is capable of providing a surface enhanced resonance effect. Typically, such capability is provided by a particle, and most particularly a metal-containing particle. Suitable particles are such as those described herein. Most suitable are those particles that are capable of providing a surface enhanced effect for surface enhanced Raman spectroscopy.

Described below are building blocks that are based on polymeric molecules and particles, including nanoparticles.

In one embodiment, where the network is obtainable from a composition comprising first and second building blocks, the first building block is a polymeric molecule and the second building block is a particle or a polymeric molecule. In one embodiment, where the network is obtainable from a composition comprising first and second building blocks, the first building block is a polymeric molecule and the second building block is a particle.

In one embodiment, where the network is obtainable from a composition comprising a first, the first building block is a polymeric molecule.

### Polymeric Molecule

In one embodiment, a building block is a polymeric molecule.

Polymeric compounds that are covalently linked to cucurbituril guest molecules are known from WO 2009/071899, which is incorporated by reference herein.

Polymeric molecules comprise a plurality of repeating structural units (monomers) which are connected by covalent bonds. Polymeric molecules may comprise a single type of monomer (homopolymers), or more than one type of monomer (co-polymers). Polymeric molecules may be straight or branched. Where the polymeric molecule is a co-polymer, it may be a random, alternating, periodic, statistical, or block polymer, or a mixture thereof. The co-polymer may also be a graft polymer.

In one embodiment, the polymeric molecule has 2, 3, 4 or 5 repeat units. For convenience, such a polymer may be referred to as an oligomer.

In other embodiments, the polymeric molecule has at least 4, at least 8, at least 15, at least 100, or at least 1,000 monomer units. The number of units may be an average number of units.

In other embodiment, the polymeric molecule has an average number of monomer units in a range selected from 10-200, 50-200, 50-150 or 75-125.

The number of guest molecules per polymeric molecule building block is as set out above. Alternatively, the number of guest molecules may be expressed as the percentage of monomers present in the polymer that are attached to guest molecules as a total of all the monomers present in the polymeric molecule. This may be referred to as the functionality percentage.

In one embodiment, the functionality of a polymeric molecule is at at least 0.5%, at least 1%, at least 2% or at least 5%.

In one embodiment, the functionality of a polymeric molecule is at most 50%, at most 40%, at most 20%, at most 15 or at most 10%.

In one embodiment, the functionality is in a range where the minimum and maximum amounts are selected from the embodiments above. For example, the functionality is in the range 5 to 40%.

The methods of the invention describe dilution methods for the release of an encapsulated component from a component. The dilution approach is particularly useful when the guest functionality of a polymeric molecule is low. Thus in one embodiment, a polymeric molecule has guest functionality, and the functionality of a polymeric molecule is at most 1%, at most 2%, at most 5%, or at most 10%.

The functionality percentage may be determined from proton NMR measurements of a polymer sample.

In one embodiment, the polymeric molecule has a molecular weight (Mw) of greater than 500, greater than 1000, greater than 2000, greater than 3000 or greater than 4000. The molecular weight may be the weight average molecular weight or the number average molecule weight. The number average and weight average molecular weights of a polymer may be determined by conventional techniques.

In one embodiment, the polymer is a synthetic polydisperse polymer. A polydisperse polymer comprises polymeric molecules having a range of molecular masses. The polydispersity index (PDI) (weight average molecular weight divided by the number average molecular weight) of a polydisperse polymer is greater than 1, and may be in the range 5 to 20. The polydispersity of a polymeric molecule may be determined by conventional techniques such as gel permeation or size exclusion chromatography.

Suitable for use in the present invention are polymeric molecules having a relatively low polydispersity. Such polymeric molecules may have a polydispersity in the range selected from 1 to 5, 1 to 3, or 1 to 2. Such polymers may be referred to as low- or monodisperse in view of their relatively low dispersity.

The use of low- or monodisperse polymeric molecules is particularly attractive, as the reactively of individual molecules is relatively uniform, and the products that result from their use may also be physically and chemically relatively uniform, and may be relatively low- or monodisperse. Methods for the preparation of low- or monodisperse polymers are well known in the art, and include polymerisation reactions based on radical initiated polymerisation, including RAFT (reversible addition-fragmentation chain transfer) polymerisiation (see, for example, Chiefari et al. Macromolecules 1998, 31, 5559). An example synthesis of a polymer having a low dispersity is also provided herein.

Many polymeric molecules are known in the art and may be used to produce shell material as described herein. The choice of polymeric molecule will depend on the particular application of the capsule. Suitable polymeric molecules include natural polymers, such as proteins, oligopeptides, nucleic acids, glycosaminoglycans or polysaccharides (including cellulose and related forms such as guar, chitosan chitosan, agarose, and alginate and their functionalised derivatives), or synthetic polymers, such as polyethylene glycol (PEG), cis-1,4-polyisoprene (PI), poly(meth)acrylate, polystyrene, polyacrylamide, and polyvinyl alcohol. The polymer may be a homo or copolymer.

The polymeric molecule may comprise two or more natural and/or synthetic polymers. These polymers may be arranged in a linear architecture, cyclic architecture, comb or graft architecture, (hyper)branched architecture or star architecture.

Suitable polymeric molecules include those polymeric molecules having hydrophilic characteristics. Thus, a part of the polymer, which part may refer to, amongst others, a monomer unit, the backbone itself, a side chain or a grafted polymer, is hydrophilic. In one embodiment, the polymeric molecule is capable of forming hydrogen bonds in a polar solvent, such as water. The polymeric molecule is soluble in water to form a continuous phase.

In one embodiment, the polymeric molecule is amphiphilic.

Where two or more building blocks are provided, such as a first and a second building block, each building block may be independently selected from the polymeric molecules described above. In one embodiment, the first and second building blocks are different. In one embodiment, the first and second building blocks are the same. In this latter case, the building blocks themselves differ only with respect to the guest molecules that are covalently attached to each.

In one embodiment, the polymeric molecule is or comprises a poly(meth)aryclate-, a polystyrene- and/or a poly(meth)arcylamide polymer.

In one embodiment, the polymer is or comprises a poly(meth)aryclate polymer, which may be or comprise a polyaryclate polymer

The acrylate functionality of the (meth)aryclate may be the site for connecting desirable functionality, for example, for connecting a solubilising group or a detectable label.

### Particle

In one embodiment, the building block is a particle. The type of particle for use in the present invention is not particularly limited.

In one embodiment, the particle is a first building block and the particle is linked to a plurality of cucurbituril guest molecules.

In one embodiment, the particle is a second building block and the particle is linked to one or more cucurbituril guest molecules.

In one embodiment, the particle is a second building block and the particle is linked to a plurality of cucurbituril guest molecules.

Typically, the particle has a size that is one, two, three or four magnitudes smaller than the size of the capsule.

In one embodiment, the particle is a nanoparticle. A nanoparticle has an average size of at least 1, at least 5, or at least 10 nm in diameter. A nanoparticle has an average size of at most 900, at most 500, at most 200, or at most 100 nm in diameter.

In one embodiment, the nanoparticle has an average size in the range 1-100 nm or 5-60 nm in diameter.

The average refers to the numerical average. The diameter of a particle may be measured using microscopic techniques, including TEM.

In one embodiment, the particles have a relative standard deviation (RSD) of at most 0.5%, at most 1%, at most 1.5%, at most 2%, at most 4%, at most 5%, at most 7%, at most 10%, at moist 15%, at most 20% or at most 25%.

In one embodiment, the particle has a hydrodynamic diameter of at least 1, at least 5, or at least 10 nM in diameter.

In one embodiment, the particle has a hydrodynamic diameter of at most 900, at most 500, at most 200, or at most 100 nM in diameter.

The hydrodynamic diameter may refer to the number average or volume average. The hydrodynamic diameter may be determined from dynamic light scattering (DLS) measurements of a particle sample.

In one embodiment, the particle is a metal particle.

In one embodiment, the particle is a transition metal particle.

In one embodiment, the particle is a noble metal particle.

In one embodiment, the particle is or comprises copper, ruthenium, palladium, platinum, titanium, zinc oxide, gold or silver, or mixtures thereof.

In one embodiment, the particle is or comprises gold, silver particle, or a mixture thereof.

In one embodiment, the particle is a gold or a silver particle, or a mixture thereof.

In one embodiment, the particle is a gold nanoparticle (AuNP).

In one embodiment, the particle is or comprises silica or calcium carbonate.

In one embodiment, the particle is a quantum dot.

In one embodiment, the particle is or comprises a polymer. The polymer may be a polystyrene or polyacrylamide polymer. The polymer may be a biological polymer including for example a polypeptide or a polynucleotide.

In one embodiment, the particle comprises a material suitable for use in surface enhanced Raman spectroscopy (SERS). Particles of gold and/or silver and/or other transition metals are suitable for such use.

Gold and silver particles may be prepared using techniques known in the art. Examples of preparations include those described by Coulston et al. (Chem. Commun. 2011, 47, 164) Martin et al. (Martin et al. Langmuir 2010, 26, 7410) and Frens (Frens Nature Phys. Sci. 1973, 241, 20), which are incorporated herein by reference in their entirety.

The particle is linked to one or more guest molecules, as appropriate. Typically, where the particle is a first building block, it is provided at least with a plurality of guest molecules. Where, the particle is a second building block, it is provided at one or more guest molecules.

In one embodiment, a guest molecule may be covalently linked to a particle via a linking group. The linking group may be a spacer element to provide distance between the guest molecule and the particle bulk. The linker may include functionality for enhancing the water solubility of the combined building block and guest molecule construct. The linker is provided with functionality to allow connection to the particle surface. For example, where the particle is a gold particle, the linker has thiol functionality for the formation of a connecting gold-sulfur bond.

Alternatively, a guest molecule may be attached directly to the particle surface, through suitable functionality. For example, where the particle is a gold particle, the guest molecule may be attached to the gold surface via a thiol functionality of the guest molecule.

In one embodiment, the particle comprises solubilising groups such that the particle, together with its guest molecules, is soluble in water or is soluble in a water immiscible phase.

The solubilising groups are attached to the surface of the particle. The solubilising group may be covalently attached to the particle through suitable functionality. Where the particle is a gold particle, the solubilising group is attached through a sulfur bond to the gold surface. The solubilising group may be, or comprise, polyethylene glycol or amine, hydroxy, carboxy or thiol functionality.

In one embodiment, the building block is obtained or obtainable from a composition comprising:
(i) a gold particle;
(ii) a guest molecule together with a linking group that has thiol functionality; and
(iii) a solubilising molecule having thiol functionality; and optionally further comprising
(iv) a further guest molecule, together with a linking group that has thiol functionality.

In one embodiment, the amount of guest molecule present in the composition is at least 1, at least 5, at least 10 or at least 15 mole %.

In one embodiment, the amount of guest molecule present in the composition is at most 80, at most 50, or most 25 mole %.

A reference to mole % is a reference to the amount of guest molecule present as a percentage of the total amount of (ii) and (iii), and (iv) where present, in the composition.

The amount of (ii) present in the composition may be such to allow the preparation of a particle building block having a plurality of guest molecules.

### Alternative Guest-Host Supramolecular Complexes

Described above are capsules having a shell that is obtainable from the supramolecular complexation of cucurbituril with building blocks covalently linked to appropriate cucurbituril guest molecules. The present invention also encompasses capsules having a shell that is obtainable from the supramolecular complexation of any host with building blocks covalently linked to appropriate host guest molecules.

As noted above, the host may be cucurbituril and the guest may be a cucurbituril guest molecule. Other guest-host complexes may be used, in the alternative to the cucurbituril guest-host complex described above.

Thus the capsule has a shell having a host that is capable of non-covalently hosting one or two guests, thereby to crosslink the building blocks to which the guests are covalently bound. The use of cucurbituril as a host is preferred owing to the high binding constants that available and the ease through which complexes, and capsules, may be assembled.

A reference to cucurbituril in the present application may be taken as a reference to an alternative host. A reference to a cucurbituril guest molecule may also be taken as a reference to an alternative host guest molecule. The preferences set out in the sections relating to the capsule, the complex, the building block, the method for preparation, and the use of the capsule apply to the alternative guest and hosts described herein, with appropriate adaptations of the features, as necessary. Thus, the inventors believe that the methods and techniques described here are generally applicable to other guest host systems.

An alternative host may be capable of forming a ternary complex. Where the complex comprises two guests within a cavity of the guest, the association constant, Kₐ, for that complex is at least 10³ M⁻², at least 10⁴ M⁻², at least 10⁵ M⁻², at least 10⁶ M⁻², at least 10⁷ M⁻², at least 10⁸ M⁻², at least 10⁹ M⁻², at least 10¹⁰ M⁻² at least 10¹¹ M⁻², or at least 10¹² M⁻². In this embodiment, the shell is a network having a plurality of complexes, wherein each complex comprises a host hosting a first guest molecule and a second guest molecule. The first and second guest molecules are covalently linked to a first building block, or to a first building block and a second building block.

An alternative host may be capable of forming a binary complex. Where the complex comprises one guest within a cavity of the guest, the association constant, Kₐ, for that complex is at least 10³ M⁻¹, of at least 10⁴ M⁻¹, of at least 10⁵ M⁻¹, of at least 10⁶ M⁻¹, of at least 10⁷ M⁻¹, of at least 10⁸ M⁻¹, of at least 10⁹ M⁻¹, of at least 10¹⁰ M⁻¹, of at least 10¹¹ M⁻¹, or of at least 10¹² M⁻¹. In this embodiment, the shell is a network having a plurality of complexes, wherein each complex comprises a host hosting one guest molecule, and each host is covalently linked to at least one other host. The guest molecules are covalently linked to a first building block, or to a first building block and a second building block.

In one embodiment, the host is selected from cyclodextrin, calix[n]arene, crown ether and cucurbituril, and the one or more building blocks have suitable host guest functionality for the cyclodextrin, calix[n]arene, crown ether or cucurbituril host respectively.

In one embodiment, the host is selected from cyclodextrin, calix[n]arene, and crown ether, and the one or more building blocks have suitable host guest functionality for the cyclodextrin, calix[n]arene, or crown ether respectively.

In one embodiment, the host is cyclodextrin and the one or more building blocks have suitable cyclodextrin guest functionality.

The host may form a binary complex with a guest. In such cases, the host will be covalently linked to one or more other guest molecules to allow the formation of crosslinks between building blocks.

In one embodiment, the host is cyclodextrin. Cyclodextrin compounds are readily available from commercial sources. Many guest compounds for use with cyclodextrin are also known. Cyclodextrin is a non-symmetric barrel shaped cyclic oligomers of D-glucopyranose. Typically, the cyclodextrin is capable of hosting hydrophobic uncharged guests. For example, guests include those molecules having hydrocarbon and aromatic functionalities such as adamantane, azobenzene, and stilbene derivatives. Other guest molecules for cyclodextrin include biomolecules such as xylose, tryptophan, estriol, esterone and estradiol.

In one embodiment, the cyclodextrin is an α-, or γ-cyclodextrin. In one embodiment, the cyclodextrin is a β- or γ-cyclodextrin. Typically larger guests are used together with a γ-cyclodextrin.

The cyclodextrin has a toroid geometry, with the secondary hydroxyl groups of the D-glucopyranose located at the larger opening, and the primary hydroxyl groups at the smaller opening. One or more of the hydroxy groups, which may the secondary or the primary hydroxy groups, may be functionalised. Typically, the primary hydroxyl groups are functionalised. In one embodiment, references to a cyclodextrin compound are references to derivatives thereof. For example, one or two primary hydroxyl groups of the cyclodextrin is functionalised with a alkylamine-containing subsistent. In another example one, two or three of the hydroxyl groups within each D-glucopyranose unit is replaced with an alkyl ether group, for example a methoxy group. A plurality of covalently linked cyclodextrins may be connected via the hydroxyl groups.

Examples of unfunctionalised and functionalised cyclodextrins are set out in Chart 1 of Rekharsky et al. (Chem. Rev. 1998, 98, 1875), and examples of compounds for use as guests are set out over Tables 1 to 3 and Chart 2. Rekharsky et al. is incorporated by reference herein.

In the methods of preparation, the cyclodextrin may be present in the second phase, for example in an aqueous phase, as described herein.

In one embodiment, the host is calix[n]arene. Calix[n]arenes compounds are readily available from commercial sources, or may be prepared by condensation of phenol, resorcinol and pyrogallol aldehydes, for example formaldehyde.

Many guest compounds for use with calix[n]arenes are known. Typically, the calix[n]arene is capable of hosting amino-containing molecules. Piperidine-based compounds and amino-functionalised cyclohexyl compounds may find use as guests. Further examples of guests include atropine, crytand, phenol blue, and anthrol blue amongst others.

Examples of unfunctionalised and functionalised cyclodextrins are set out in Chart 1 of Danil de Namor et al. (Chem. Rev. 1998, 98, 2495-2525), which is incorporated by reference herein. Examples of compounds for use as guests are set out over Tables 2, 3, 5 and 10 of Danil de Namor et al.

In one embodiment, the calix[n]arene is a calix[4]arene, calix[5]arene or calix[6]arene. In one embodiment, the calix[n]arene is a calix[4]arene.

Suitably functionalised calix[n]arenes may be prepared through use of appropriately functionalised hydroxy aryl aldehydes. For example, the hydroxyl group may be replaced with an alkyl ether-containing group or an ethylene glycol-containing group. A plurality of covalently linked calix[n]arenes may be connected via the hydroxyl groups.

In the methods of preparation, the calix[n]arene may be present in the second phase, for example in an aqueous phase or a water immiscible phase, as described herein.

In one embodiment, the host is a crown ether. Crown ether compounds are readily available from commercial sources or may be readily prepared.

Many guest compounds for use with crown ether are also known. For example, cationic guests such as amino- and pyridinium-functionalized molecules may be suitable guest molecules.

Examples of unfunctionalised and functionalised cyclodextrins are set out throughout Gokel et al. (Chem. Rev. 2004, 104, 2723-2750), which is incorporated by reference herein. Examples of compounds for use as guests are described throughout the text.

In one embodiment, the crown ether is selected from the groups consisting of 18-crown-6, dibenzo-18-crown-6, diaza-18-crown-6 and 21-crown-7. In the present invention, larger crown ethers are preferred. Smaller crown ethers may have be capable of binding small metal ions only. Larger crown ethers are capable of binding functional groups and molecules.

In some embodiments, the host is a guest having crown ether and calix[n]arene functionality. Such hosts are referred to as calix[n]crowns.

In the methods of preparation, the crown ether may be present in the second phase, for example in a water immiscible phase, as described herein.

Other guest-host relationships may be used as will be apparent to a person of skill in the art. Other guest-host complexes for use in the present invention include those highlighted by Dsouza et al. (Chem. Rev. 2011, 111, 7941-7980) which is incorporated by reference herein, and in particular those hosts set out in Schemes 6 and 7, which includes cucurbituril, cyldoextrin, and calixerane as well as cyclophane AVCyc, calixpyridine C4P and squarimide SQAM.

The use of cyclodextrin is preferred over crown ether and calix[n]arene hosts.

### Composition

In one aspect of the invention there is provided a composition comprising a capsule holding a component, for example a catalyst, such as an enzyme, where the capsule has a shell of material that is a supramolecular cross-linked network.

In a further aspect there is provided a cleaning composition comprising a capsule having a shell which is obtainable from the complexation of a composition comprising cucurbituril and one or more building blocks having suitable cucurbituril guest functionality thereby to form a supramolecular cross-linked network, wherein the capsule encapsulates a component, such as a catalyst.

The cleaning composition may be a detergent composition for use in cleaning dirty items, a laundry composition for cleaning dirty laundry or a dishwashing composition for cleaning utensils, pots, pans, crockery and cutlery.

The composition may further comprise excipients such as caking inhibitors, colouring agents, masking agents, enzyme activators, antioxidants, and solubilizers. The composition may further comprise one or more catalyst such as enzymes.

A composition may be a liquid or a solid, such as powder, composition.

The present case also provides a method of preparing a composition, the method comprising the step of mixing a capsule as described herein with one or more excipients, such as those for use in a cleaning or detergent composition, and such as those excipients discussed above.

In this method, the capsule may be substantially free of water. Thus, a preliminary step in the method of preparing the composition may include drying the capsule thereby to reduce the water content of the capsule, for example so that the capsule is substantially free of water. The capsule may be dried to constant mass.

A dried capsule may be easier to formulate and transport than a hydrated capsule, particularly when it is to be used a powder composition.

In methods of the invention, the contents of the capsule may be released when the capsule is diluted, for example with water. In these embodiments, it is preferable that the capsule has a relatively low water content prior to its dilution.

### Methods for the Preparation of Capsules

Capsule of the invention and capsules for use in catalysis reactions may be prepared according to the techniques described in WO 2013/014452, adapted accordingly as appropriate.

A capsule for use in catalysis may be prepared according to the procedures in WO 2013/014452, where a second fluid flow is dispersed in a first continuous phase. The second phase is provided with a catalyst, typically together with a host and building blocks having suitable guest functionality. The dispersed phase forms droplets containing that catalyst. The shell of material forms at the droplet boundary, thereby to encapsulate the catalyst. The shell materials may be brought together with the catalyst in a fluid flow immediately prior to the dispersion of that fluid flow in the continuous phase.

A capsule having a high loading of catalyst may be prepared using the flow preparation techniques described in WO 2013/014452. The concentration of the catalyst provided in the second phase may be increased in order to provide a high loading catalyst.

In one embodiment, the concentration of a component, such as a catalyst, in the fluid flow is at least 2, at least 5, at least 10, at least 20, at least 40, at least 50, or at least 50 mg/mL. In one embodiment, the concentration of the catalyst in the fluid flow is the range 2 to 10 mg/mL, such as 2 to 7 mg/mL.

In one embodiment, the concentration of a component, such as a catalyst, in the fluid flow is at least 10 nM, at least 50 nM, at least 100 nM, at least 200 nM, at least 500 nM, at least 1 M, at least 5 μM, at least 10 μM or at least 50 μM.

A droplet that is formed from a fluid flow, such as using the techniques described herein, will naturally comprise a component at the concentration of the originating fluid flow. A capsule formed from that droplet, for example where the shell at the boundary of droplet surface may have substantially the same volume as the droplet, and it follows that the concentration of the component will be substantially the same as that of the droplet. The capsule may be at least partially dried after its preparation, thereby to remove solvent from the capsule. The concentration of the component with capsule shell may therefore be increase as a result. The concentration may be decreased by subsequent resolvation of the capsule, as described herein.

The capsule may be dried after it is prepared, such that there is substantially no water present. In this form the capsule may be incorporated into a composition, as described above.

The thickness of the capsule shell may be minimised by minimising the quantity of shell forming material in a fluid flow. Thus, there will be less material available at the droplet boundary, and the thickness of the shell will be reduced accordingly. Thus, the concentration of host and/or building block in the second phase may be decreased in order to provide a capsule shell having a relatively low amount of material.

The worked examples in the present case also describe capsules holding catalysts, such as enzymes.

### Method of Catalysis

The present invention provides a method of catalysis. The method comprises the step of catalysing the reaction of a reagent in the presence of a catalyst, wherein a capsule holds the catalyst, and the capsule has a shell of material that is a supramolecular cross-linked network.

The catalyst reaction may include the reaction of a first reagent and a second reagent in the presence of the catalyst.

In one embodiment, the method includes the preliminary step of permitting a reagent to enter the capsule.

In one embodiment, the method includes the subsequent step of collecting the capsule, optionally together with a product that is contained within the capsule.

In one embodiment, the method includes the subsequent step of permitting a product to pass out of the capsule. The product may then be separated from the capsule containing the catalyst.

The catalysis reaction may be studied using standard spectroscopic techniques. For example, the change in the amount of reagent or product concentration may be associated with a change in fluorescent intensity, which may be detected by fluorimeter.

The capsule may be immobilised, for example to a surface. Such may be useful for flow methods of catalysis.

### Methods of Release and Delivery

The supramolecular network of the capsule may be disrupted using a dilution release. In this way, a component encapsulated by a capsule may be released. Thus, a capsule or a collection of capsules may be dispersed in a liquid, thereby to release an encapsulant.

Without wishing to be bound be theory, the inventors believe that the supramolecular network is disrupted in response to a change in the pressure, such as osmotic pressure, across the shell during the dilution step.

The capsules of the present case may be at least partially dehydrated (such as dried) after their preparation. Subsequently, the capsules may be diluted, as required and as necessary, to release an encapsulated component. An appropriate diluent is used.

The dilution may be a 5 or more, 10 or more, 50 or more, 100 or more, 1,000 or more, or a 10,000 or more fold dilution of the capsules.

Typically the dilution is a 10 or more fold dilution of the capsule. For example, in the worked examples, a 5 μL sample of capsules is diluted ten fold to 50 μL to release the encapsulated component.

The dilution approach is favoured where the capsule has a relatively low level of crosslinking, for example, where the amount of host is reduced, and/or the number of guests is reduced (for example a polymeric molecules having a reduced guest functionality), and/or the guests are replaced with alternative guests having a lower affinity for the host.

In one embodiment, the diluent is an aqueous solution, including water. In one embodiment, the dilution is performed within a washing machine, such as a laundry washing machine or a dishwasher.

In one embodiment the release of the encapsulated component is in response to an external stimulus.

In one embodiment, the external stimulus is selected from the group consisting of competitor guest compound, light, oxidising agent, and reducing agent.

In one embodiment the release of the encapsulated component is in response to a change in the local conditions.

In on embodiment, the change in local conditions may be a change in pH, a change in temperature, a change in oxidation level, change in concentration, or the appearance of a reactive chemical entity.

In one embodiment, the release of the encapsulant is achieved by disrupting the complex formed between the cucurbituril and the guest molecule or molecules. In one embodiment, a compound covalently linked to a competitor guest molecule is provided at the release location. The competitor guest molecule displaces a guest molecule of a building block thereby to disrupt the network that forms the capsule shell. Such disruption may cause pores to appear in the shell, through which the encapsulated compound may pass through and be released. In one embodiment, the competitor guest molecule causes an extensive disruption of the capsule shell.

In one embodiment, the release of the encapsulant is achieved by disrupting the complex using light, for example an incident laser light. In their experiments to determine the surface enhanced spectroscopic properties of the capsules of the invention (for examples those capsule containing particles), the present inventors have found that exposure of the capsule to a laser light results in the at least partial loss of integrity of the capsule.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### Experimental and Results

The general procedures for preparing capsules and nested capsules are described in detail in WO 2013/014452, PCT/GB2014/050259 and Zhang et al.

Examples 1 to 3 relate to the use of enzymes within a capsule. Example 4 relates to the use of capsules within a cleaning composition. Example 5 relates to the use of dilution as a method for releasing an encapsulated cargo. Examples 1 to 3 also show the preparation of capsules having a high catalyst loading and a low shell content.

Black and white optical microscope images were recorded using an inverted microscope (IX71, Olympus) connected to a Phantom fast camera (V72, Vision Research), and analysed using Phantom software. Fluorescence images of microcapsules were recorded using an EM-CCD camera (Xion+, Andor Technologies) connected to an inverted microscope (IX 71, Olympus) operating in epifluorescence mode. A mercury lamp was installed for wide-spectrum illumination with FITC filters and dichroics fitted to separate the fluorescence excitation and emission light. A computer-controlled shutter was added to the excitation path to reduce the time during which the specimen was excited upon to minimise photobleaching. The camera, the stage and the shutter were controlled by a custom-written software (LabVIEW 8.2, National Instruments), which was used to record and analyse bright field and fluorescence images. All starting materials were purchased from Alfa Aesar and Sigma Aldrich and used as received unless stated otherwise. CB[8] was prepared as documented previously by Kim et al. (J. Am. Chem. Soc. 2000, 122, 540) All aqueous phase was dissolved in deionised water treated with a Milli-Q™ reagent system ensuring a resistivity of >15 MΩcm⁻¹. Buffers were adjusted using a pH meter (Seveneasy™, Mettler Toledo) calibrated with buffers of pH 4, 7, and 10 (Fisher Scientific).

### Activity of Encapsulated Enzymes

The activity of an enzyme was examined to verify whether a catalyst would retain catalytic activity upon encapsulation. Enzymes were chosen as a model protein since its activity is defined as the amount of product generated in a given amount of time under given conditions as a function of the amount of total protein, and hence can be easily measured. A suitable substrate for any enzyme assay should produce a product that is, for example, coloured, UV-absorbant, or fluorescent, a property that can be easily monitored by an analytical method.

In a typical enzyme activity assay, enzyme-containing droplets were collected into an assay vessel (for example, a microtitre plate or a cuvette). The droplet also contains material for a supramolecular shell and the capsule shell was allowed to form at room temperature, at the boundary of the droplet in the continuous oil phase (as described in further detail below). The enzyme samples were then redispersed in buffer to a concentration that is optimal for the detection method and within the detection limit using an appropriate buffer. The enzyme samples were then incubated at the optimal temperature for an extended period of time, before a buffer solution of the substrate was added and the product generation was monitored using the appropriate analytical method. After background correction, the initial linear portion of the results was used to calculate the slope, which corresponds to the enzyme activity in this particular experimental condition.

### Example 1

To encapsulate α-amylase (from porcine pancreas, Sigma, 51-54 kDa), a stock enzyme solution (5 mg in 1 mL in 0.05 M 3-(N-morpholino)propanesulfonic acid (MOPS) buffer) was made in the presence of excipients including NaCl (2 mg), CaCl₂ (2 mg), trehalose (20 mg), and dextran (about 40,000 g/mol, 5 mg). A capsule solution was also made from a mixture of CB[8], methyl viologen-functionalised polyvinyl alcohol and naphthol-functionalised polyvinyl alcohol ([CB[8]]=[methyl viologen]=[naphthol]=approx. 1:1:1 mole ratio).

The Mw of PVA-MV was about 109,000 g/mol with 10% methyl viologen (MV) functionalization. The Mw of PVA-Np was about 69,000 g/mol with 10% naphthol (Np) functionalization. Additionally both PVA-MV and PVA-Np polymers had 1% rhodamine functionalization.

Each polymer molecule contains approximately 200 guests i.e. 200 naphthol or methyl viologen guests.

Enzyme-encapsulating droplets were made using a two-inlet flow-focusing microfluidic device by introducing the two aqueous solutions separately while combining in channel before being sheared off into microdroplets at a frequency of 300 Hz. Immediately after generation, droplets passed through a winding channel that is designed for thorough mixing of the two solutions in the channel. Droplets were collected through an outlet tubing into wells of a microtitre plate. The collection time was calculated to be 5 seconds to yield a final concentration of enzyme per well of 100 mU/mL.

The enzyme concentration in the formed droplet was 2.5 mg/mL. The diameter of the droplet formed was 55 μm. The volume of the droplet was therefore 8.7×10⁻¹⁴ m³ (8.7×10⁻¹¹ L). The amount of enzyme in the capsule was therefore 2.2×10⁻¹⁰ mg. The weight percentage of the capsule, that is the weight of the cargo as a percentage of the total weight of the capsule, was 82%.

Droplets containing α-amylase only in the absence of the capsule mixture were also prepared as a control by replacing the enzyme stock solution with buffer. The droplets were then allowed to dehydrate in air for approximately 5 hours before the enzyme activity was checked using a solution-based fluorescence assay (EnzCheck® Ultra Amylase Assay Kit, Molecular Probes™). The preparation of all reagents was performed according to the assay kit instructions. Reaction buffer (50 μL) was first pipetted into the microtitre wells to rehydrate the enzyme-containing capsules before 50 μL of the DQ™ substrate (200 μg/mL) was quickly added and mixed to all wells containing the enzyme test samples using a multichannel pipettor. The samples were then incubated at room temperature for 30 minutes and the fluorescence intensity was measured in a fluorescence microtitre plate reader. Each data point was corrected for background fluorescence by subtracting the value obtained from the no-enzyme blank and the linear region of the curve was used to calculate the specific enzyme activity. 100% Amylase activity was obtained by performing the assay using free amylase in buffer without going through the microfluidic process. Relative enzyme activity was then obtained by comparing the specific activity with that of the free enzyme.

It is noted that the rehydration of the capsules in the experiment above was not associated with the release of the encapsulated catalyst in contrast with the work described in Example 5. The capsules of Example 1 make use of a polymers having a relatively high guest functionalization (10%, as noted above). In contrast, the polymers used in Example 5 have a relatively low guest functionality (2%).

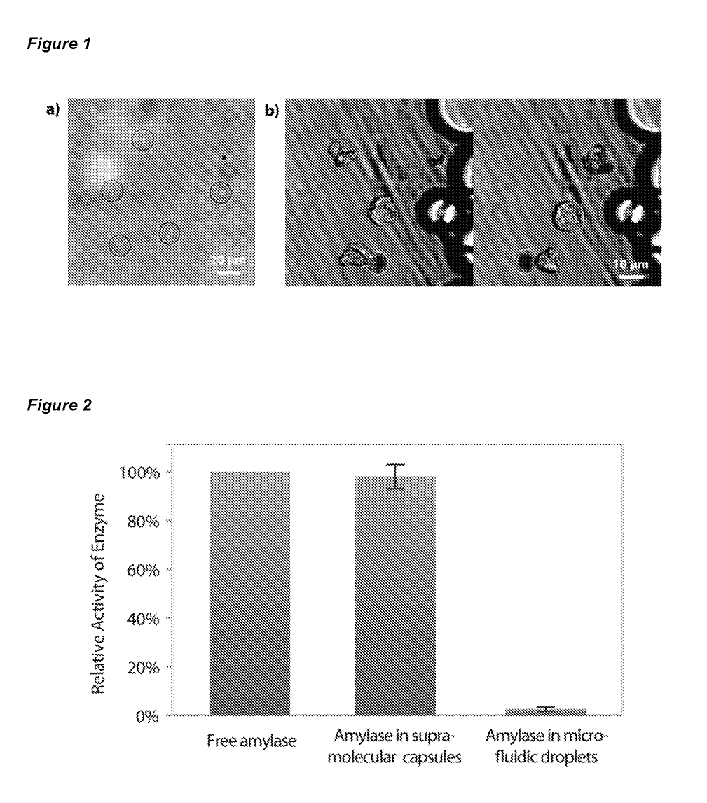

FIG. 1 includes light microscopic images showing the formation of microcapsules containing α-amylase. The capsules are formed at a droplet boundary. The capsules may be partially dried, with the result that the capsules lose their spherical shape and become smaller, shrivelled structures (as seen in the microscopic images).

The formation of capsules was observed during dehydration of the microdroplets at room temperature (FIG. 1 (a)). The process follows the same pattern as hollow microcapsule formation as previously published (see WO 2013/014452). In the final stage of the droplets shrinking, the complete formation of the microcapsule was visible as the spherical shape of the droplet was distorted before the structures further shrivelled (FIG. 1), as a result of the pressure difference across the capsule shell created by dehydration. This is on account of the in situ formation of the microcapsule shell as the materials spontaneously self-assemble at the water/oil interface while interlocked with CB[8] via host-guest ternary complexation.

Given that α-amylase catalyses the hydrolysis of starch to a mixture of maltose, maltotriose and dextrins, the activity of α-amylase was measured using the solution-based fluorescence assay provided by the EnzCheck® Ultra Amylase Assay Kit of Molecular Probes™. The starch substrate is labeled with a BODIPY dye with quenched fluorescence, and upon α-amylase catalysis, the quenching is removed and the resulting highly fluorescent fragments can be used to indicate the amount of production formation when monitored using a fluorimeter.

As the example above shows, material from the fluorescence assay kit is permitted to pass into a supramolecular capsule, and the catalyst held within the capsule catalyse the reaction of the material from the fluorescence assay kit thereby yielding a detectable signal.

FIG. 2 shows that amylase contained in supramolecular capsule retains catalytic activity. This activity is comparable to the free amylase in solution. In contrast, where the amylase is provided in a droplet (one that does not have the components for forming a shell), the amylases loses nearly all catalytic activity, presumably due to denaturing caused by spontaneous adsorption of enzyme to water-oil interface. When no enzyme is present in the buffer, the resulting dehydrated samples of microdroplets or microcapsules showed no catalytic capability (as expected). This comparison demonstrates that the microcapsules do not interfere with the enzyme functionality, but also serve as a protective layer for the entrapped enzyme and prevent it from being denatured at the water/oil interface.

### Example 2

To encapsulate alkaline phosphatase (from bovine intestina mucosa, Sigma, ca. 140 to 160 kDa), a stock enzyme solution (200 nM in 1 M diethanolamine (DEA) buffer) was made in the presence of excipients including MgCl₂ (1 mM) and ZnCl₂ (20 μM). A capsule solution was also made from a mixture of CB[8], methyl viologen-functionalised polyvinyl alcohol and naphthol-functionalised polyvinyl alcohol, as used above ([CB[8]]=[methyl viologen]=[naphthol]=approx. 1:1:1 mole ratio). MgCl₂ and ZnCl₂ are standard excipients to stabilise the alkaline phosphatase.

Each polymer molecule contains approximately 200 guests i.e. 200 naphthol or methyl viologen guests.

The enzyme concentration in the droplet formed during the method of preparation was 100 nM. The diameter of the droplet was 55 μm, and the volume of the droplet was 8.7×10⁻¹⁴ m³ (8.7×10⁻¹¹ L). The amount of enzyme in each droplet was 8.7×10⁻⁹ nmol. The weight percentage of the cargo was 96 wt %.

Enzyme-encapsulating droplets were made using a one-inlet flow-focusing microfluidic device by introducing an equivolume mixture of the two aqueous solutions before being sheared off into microdroplets at a frequency of 300 Hz. Droplets were collected into wells of a microtitre plate. The collection time was calculated to be 45 seconds to yield a final concentration of enzyme per well of 25 nM.

Droplets containing only the enzyme in the absence of the capsule mixture were also prepared as a control by replacing the enzyme stock solution with buffer. The droplets were then allowed to dehydrate in air for approximately 8 hours before the enzyme activity was checked at different time intervals using fluorescein diphosphate as the substrate.

DEA buffer (50 μL) was first pipetted into the microtitre wells to rehydrate the enzyme-containing capsules before 50 μL of the substrate (5 μM in DEA buffer) was quickly added to all wells containing the enzyme test samples using a multichannel pipettor. The fluorescence intensity was measured in a fluorescence microtitre plate reader where each data point was corrected for background fluorescence by subtracting the value obtained from the no-enzyme blank. The linear region of the curve was used to calculate the specific enzyme activity. 100% alkaline phosphatase activity was obtained by performing the assay using free enzyme in buffer. The sample was stored at 4° C. before it was assayed at the subsequent time intervals. Relative enzyme activity was then obtained by comparing the specific activity with that of the free enzyme.

Droplets were generated as described above and the alkaline phosphatase-containing capsules were obtained after dehydration. The activity of the enzyme was measured using fluorescein diphosphate as the substrate, which is known to be hydrolysed to form highly fluorescent fluorescein, the formation of which can be monitored using a fluorimeter.

The results are summarized in FIG. 3. The relative activity of alkaline phosphatase was obtained by comparing the activity of samples with that of the free enzyme in buffer. Immediately after encapsulation, the activity of alkaline phosphatase was quantitatively preserved, whereas in the control experiment where the capsule mixture was absent during the droplet formation the activity of AP was not observed. Long-term monitoring of the enzyme activity suggests that despite the initial decrease in activity over the next 24 h to approximately 40% of the free enzyme, very little decrease in activity was observed in the next two days. It is postulated that while enzyme is protected in the microcapsules and some activity was preserved, a decrease in activity is caused by the inactivation of enzyme that was adjacent to the water/oil interface during the formation process. Pleasingly this was not observed in the amylase experiments described above.

### Example 3

To encapsulate lipase (from Rhizomucor Mie, Sigma, 45 to 50 kDa), a stock enzyme solution (10 kU/mL in 50 mM Tris buffer with 50 mM NaCl, pH 8, 19.62 mg/mL) was made. A capsule solution was also made from a mixture of CB[8] (M_{W} 1,708), methyl viologen-functionalised polyvinyl alcohol (M_{W} about 109 kDa) and stilbene-functionalised polyvinyl alcohol (M_{W} about 72.73 kDa). CB[8], methyl viologen and stilbene were present at a approx. 1:1:1 mole ratio.

Each polymer molecule contains approximately 200 guests i.e. 200 stilbene or methyl viologen guests.

The polymers were prepared at a concentration of 1.5 μM each and CB[8] was prepared at a concentration of 322 μM.

The enzyme stock solution was brought together with the reagents for shell formation in an aqueous flow immediately prior to dispersion in an oil phase (resulting in the effective dilution of the enzyme solution and the reagent solution). The concentration of the enzyme in the aqueous flow, and therefore the droplet also, was 6.54 mg/mL.

The concentration of the CB[8] in the aqueous flow was 214 μM and the concentration of the polymers was 1 μM, hence the concentration of each guest was about 200 μM.

Enzyme-encapsulating droplets were made using a one-inlet flow-focusing microfluidic device by introducing a mixture of the two aqueous solutions before being sheared off into microdroplets at a aqueous flow rate of 50 μL/h and oil flow rate of 200 μL/h. Droplets were collected into wells of a microtitre plate. The collection time was calculated to be 8 seconds to yield a final concentration of enzyme per well of 12 U/mL. The droplets were then allowed to dehydrate in air for approximately 5 hours before the enzyme activity was checked at different time intervals using p-nitrophenyl butyrate as the substrate.

The diameter of the droplet was 55 μm, and the volume of the droplet was 8.7×10⁻¹⁴ m³ (8.7×10⁻⁸ mL).

The enzyme concentration per droplet was 6.5 mg/mL. The amount of enzyme in each droplet was therefore 5.7×10⁻⁷ mg.

The amount of CB[8] in a droplet was 3.19×10⁻⁸ mg.

The amount of each polymer in a droplet was 9.49×10⁻⁹ mg (methyl viologen polymer) and 6.33×10⁻⁹ mg (stilbene polymer).

The weight percentage of the cargo was therefore 92 wt % (5.7×10⁻⁷/5.7×10⁻⁷+9.49×10⁻⁹+6.33×10⁻⁹+3.19×10^{-8×100}).

A similar capsule holding lipase in a methyl viologen-functionalised polyvinyl alcohol and a viologen-functionalised polyvinyl alcohol capsule was prepared in a similar manner. The polymers were the polymers from Example 1. This capsule was tested as described below.

Tris buffer (75 μL) was first pipetted into the microtitre wells to rehydrate the enzyme-containing capsules before 75 μL of the substrate (1 mM in Tris buffer) was quickly added and mixed to all wells containing the enzyme test samples using a multichannel pipettor. The sample was incubated at 37° C. for 10 minutes before the UV absorbance was measured in a microtitre plate reader where each data point was corrected for background by subtracting the value obtained from the no-enzyme blank. The linear region of the curve was used to calculate the specific enzyme activity. 100% lipase activity was obtained by performing the assay using free lipase in buffer. The sample was stored at room temperature before it was assayed at the subsequent time intervals. Relative enzyme activity was then obtained by comparing the specific activity with that of the free enzyme. The rehydration of the capsules in buffer was also monitored using fluorescence microscopy by imaging the capsules before and after the addition of Tris buffer on a microscope slide.

The droplets containing the capsule mixture and the enzyme were allowed to dry at room temperature to yield lipase-containing capsules. The capsules were then redispersed in TRIS buffer before the enzyme activity was checked using p-nitrophenyl butyrate as the substrate, which generates coloured 4-nitrophenyol upon lipase catalysis to break the ester bond.

The microscopic images of the capsule (FIG. 4) revealed that the enzyme was fully contained within the capsule, as shown by the perfectly spherical shape of the capsule shell highlighted with rhodamine fluorescence. This can be attributed to the high loading percentage of the enzyme, in this case more than 92 wt %. Upon rehydration in TRIS buffer, the capsule swelled in size and the spherical shape of the capsule was maintained, an indication that the enzyme was still being encapsulated when it was hydrolyzing the ester bond of p-nitrophenyl butyrate.

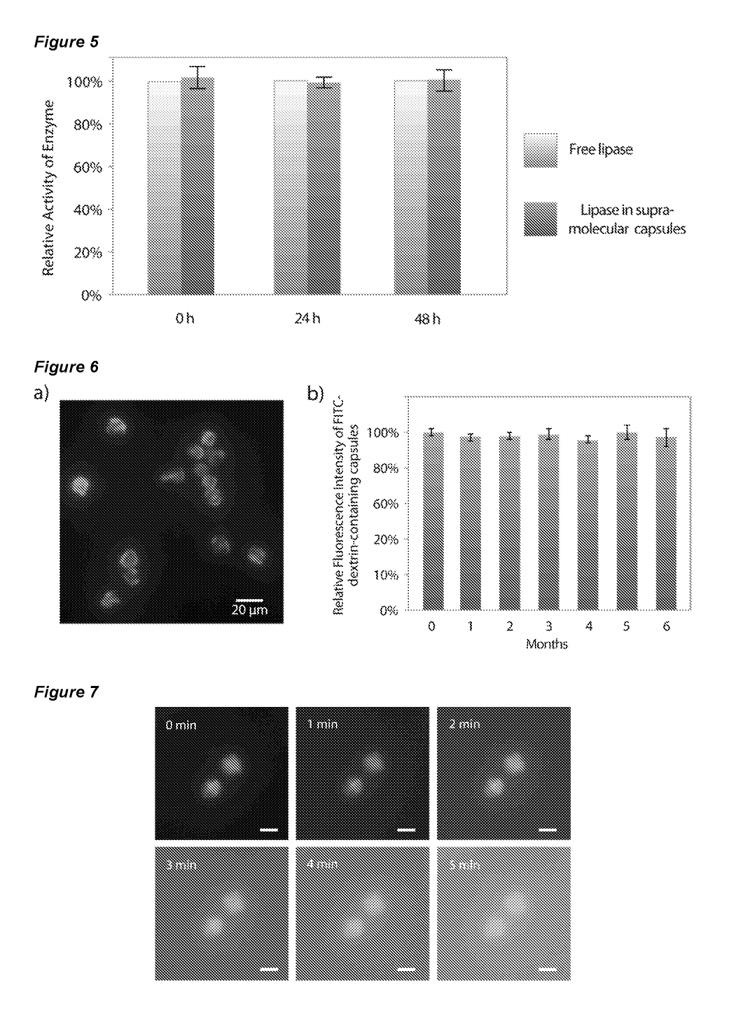

The results of the lipase activity study are shown in FIG. 5. The relative activity of lipase was obtained by comparing the activity of experimental samples with that of the free enzyme in TRIS buffer. Immediately after encapsulation, the activity of lipase was quantitatively preserved, and prolonged monitoring of the enzyme activity suggests that very little decrease in activity was observed in the next two days. This indicates that lipase was able retain its catalytic ability when encapsulated inside supramolecular microcapsules, and its activity was maintained at room temperature for at least 48 hours without significant loss.

### Example 4

To use the encapsulated functional proteins in commercial applications, it was important to investigate the robustness of the supramolecular capsules in off-the-shelf formulations. This was achieved by encapsulating FITC-dextran as a model cargo before monitoring the long-term stability of the supramolecular capsules in off-the-shelf cleaning compositions, which was measured with the localisation of the FITC fluorescence over time. FITC-dextran-encapsulating supramolecular capsules were first prepared, before they were immersed in a clear off-the-shelf formulation. A clear formulation was chosen to avoid optical disturbance of the FITC fluorescence. Fluorescence images of the dextran-containing capsules were obtained at various time intervals at room temperature for six months.

Standard capsules containing 500 k Da FITC-dextran (5 μM) were prepared using the standard microfluidic droplet method. Capsules were made from a mixture of CB[8], methyl viologen-functionalised polyvinyl alcohol and naphthol-functionalised polyvinyl alcohol ([CB[8]]=[methyl viologen]=[naphthol]=100 uM), and droplets were made from a one-inlet microfluidic device with aqueous flow rate of 100 μL/h and oil flow rate of 200 μL/h. They were allowed to dry on a glass bottom petri dish before off-the-shelf detergents were added. The samples were stored at room temperature and the FITC fluorescence intensity of the dextran-containing capsules was monitored using a fluorescence microscope. 100% florescence intensity was measured at time zero. Twenty capsules were measured before the average fluorescence intensity was calculated. To trigger the release of the dextran from these capsules, the layer of off-the-shelf detergent was removed using a pipette before a solution of 1-adamantamine (1 mM) was added to the petri dish. The release of the fluorescence was monitored at various time intervals using a fluorescence microscope.

The results are shown in FIG. 6 (b). The fluorescence intensities of 10 capsules were measured, averaged, and converted to a relative fluorescence intensity compared with the initial measurement at time 0. It was clear the fluorescence intensity of FITC-dextran in supramolecular capsules was maintained over six months in the off-the-shelf formulation. Fluorescence images taken at various time intervals also confirmed the localization of fluorescence within each microcapsule (data not shown). It is therefore concluded that the supramolecular microcapsules were robust in off-the-shelf formulations for at least six months at room temperature.

The ability to be triggered to release the encapsulated cargos was also examined at the end of the six months storage in the formulation. As an example, the competitive guest trigger was used where an aqueous solution of 1-adamantamine was added to the microcapsules after the removal of the formulation. The FITC fluorescence was recorded at different time intervals as an indicator of the release or retention of the encapsulated cargo.

The result is summarised in FIG. 7, showing that FITC fluorescence started to dissipate after one minute and was largely released by the fifth minute. This clearly showed that the supramolecular capsules were able to retain their trigger-to-release property while being stored in an off-the-shelf formulation, while upon the application of a stimulus, they were able to release the cargo on demand. This result indicates a promising start, while with further development in formulation, the supramolecular microcapsule system could be used as a long-term storage capability for functional proteins.

### Example 5

To demonstrate that dilution can be used as a mechanism to release the enzyme cargo from the capsules, cargo-containing capsules were first prepared using lipase as the cargo in the microfluidic droplet method described above. Both polymers used in the capsule shell have a polyvinyl alcohol backbone with 2% guest loading of methyl viologen and naphthol respectively (with an additional 1% loading of rhodamine label).

An aqueous solution of the polymers and CB[8] ([MV]=[Np]=[CB[8]]=100 μM) and an aqueous solution of the enzyme (0.2 g/L, containing FITC-labelled dextran, Mw 40,000 g/mol, 6.4 g/L) were made. Droplets were generated in oil from the combination of these aqueous solutions with a diameter of 100 μm.

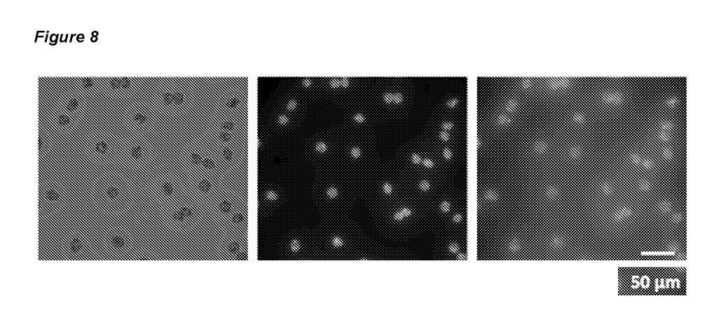

Upon dehydration, stable capsules containing lipase as a cargo were obtained with 80 wt % cargo loading. These capsules were also stable in liquid laundry detergent, as shown in FIG. 8 where the FITC fluorescence was localized within the capsules even when stored in the detergent (a commercially available detergent was used in this study). Some background fluorescence was also observed due to certain fluorescent component in the liquid detergent.

When the capsules were rehydrated in pure water, the dissipation of the fluorescence was instantaneously observed (FIG. 8), suggesting dissolution of the capsule shell and a complete release of the lipase cargo. This is presumably caused by the difference in osmotic pressure across the capsule shell as a result of dilution in water.

In the dilution experiment, 5 μL of a capsule sample was diluted to 50 μL with water. This tenfold dilution was accompanied by a release of the enzyme cargo.

### REFERENCES

All documents mentioned in this specification are incorporated herein by reference in their entirety.
Kim et al. J. Am. Chem. Soc. 2000, 122, 540
WO 2013/014452
PCT/GB2014/050259
Zhang et al. Science 2012, 335, 6069

1. A method of catalysis, the method comprising the step of catalysing the reaction of a reagent in the presence of an enzyme, wherein a capsule holds the enzyme and the capsule has a shell of material that is a supramolecular cross-linked network.

2. The method of claim 1, wherein the shell is obtainable from the complexation of a composition comprising a host and one or more building blocks having suitable host guest functionality thereby to form a supramolecular cross-linked network.

3. The method of claim 1, wherein the method includes the preliminary step of permitting a reagent to enter the capsule.

4. The method of claim 1, wherein the method includes the subsequent step of collecting the capsule, optionally together with product that is contained within the capsule.

5. The method of claim 1, wherein the method includes the subsequent step of permitting a product to pass out of the capsule.

6. The method of claim 5, wherein the product is separated from the capsule.

7. The method of claim 2, wherein the host is selected from cucurbituril, cyclodextrin, calix[n]arene, and crown ether, and the one or more building blocks have suitable host guest functionality for the cucurbituril, cyclodextrin, calix[n]arene or crown ether host.

8. The method of claim 1, wherein the host is cucurbituril and the one or more building blocks have suitable cucurbituril guest functionality.

9. The method of claim 8, wherein the shell is obtainable from the complexation of (a) a composition comprising cucurbituril and (1) or (2); or (b) a composition comprising a plurality of covalently linked cucurbituril and (1), (2) or (3), wherein:
(1) comprises a first building block covalently linked to a plurality of first cucurbituril guest molecules and a second building block covalently linked to a plurality of second cucurbituril guest molecules, wherein a first guest molecule and a second guest molecule together with cucurbituril are suitable for forming a ternary guest-host complex.
(2) comprises a first building block covalently linked to a plurality of first cucurbituril guest molecules and a plurality of second cucurbituril guest molecules, wherein a first and a second guest molecule together with cucurbituril are suitable for forming a ternary guest-host complex and optionally the composition further comprises a second building block covalently linked to one or more third cucurbituril guest molecules, one or more fourth cucurbituril guest molecules or both, wherein a third and a fourth molecule together with cucurbituril are suitable for forming a ternary guest-host complex, and/or the first and fourth molecules together with cucurbituril are suitable for forming a ternary guest-host complex, and/or the second and third molecules together with cucurbituril are suitable for forming a ternary guest-host complex; and
(3) comprises a first building block covalently linked to a plurality of first cucurbituril guest molecules, wherein the first guest molecule together with the cucurbituril are suitable for forming a binary guest-host complex. Optionally the composition further comprises a second building block covalently linked to one or more second cucurbituril guest molecules, wherein the second guest molecule together with the cucurbituril are suitable for forming a binary guest-host complex.

10. The method of claim 9, wherein the shell is obtainable from the complexation of a composition comprising cucurbituril and (1) or (2).

11. The method of claim 10, wherein the shell is obtainable from the complexation of a composition comprising cucurbituril and (1).

12. The method of claim 7, wherein the cucurbituril is selected from CB[8] and variants and derivatives thereof.

13. The method of claim 12, wherein the cucurbituril is CB[8].

14. The method of claim 12, wherein the cucurbituril forms a ternary complex with a first guest molecule and a second guest molecule, and the first and second guest molecules are selected from the following pairs:
viologen and naphthol;
viologen and dihydroxybenzene;
viologen and tetrathiafulvalene;
viologen and indole;
methylviologen and naphthol;
methylviologen and dihydroxybenzene;
methylviologen and tetrathiafulvalene;
methylviologen and indole;
N,N′-dimethyldipyridyliumylethylene and naphthol;
N,N′-dimethyldipyridyliumylethylene and dihydroxybenzene;
N,N′-dimethyldipyridyliumylethylene and tetrathiafulvalene;
N,N′-dimethyldipyridyliumylethylene and indole;
2,7-dimethyldiazapyrenium and naphthol;
2,7-dimethyldiazapyrenium and dihydroxybenzene;
2,7-dimethyldiazapyrenium and tetrathiafulvalene; and
2,7-dimethyldiazapyrenium and indole.

15. The method of claim 2, wherein the first building block is a polymeric molecule.

16. The method of claim 15, wherein the polymeric molecule is a polyvinyl alcohol, optionally labelled.

17. The method according to claim 1, wherein the capsule size is in range from about 10 to about 100 μm in diameter.

18. The method according to claim 1, wherein the capsule diameter has a relative standard deviation (RSD) of at most 10%.

19. The method according to claim 1, wherein the shell pore size is in range 1 to 20 nm.

20. The method according to claim 1, wherein the shell has a thickness of at most 20 μm.

21. The method according to claim 1, wherein the enzyme is present in the capsule at a concentration of at least 0.5 mg/mL.

22. The method according to claim 1, wherein the enzyme is present at 50 wt % or more, as a percentage of the total amount of component and the capsule shell.

23. A capsule having a shell of material that is a supramolecular cross-linked network, wherein the capsule holds an enzyme and the capsule further holds a reagent and/or a product, wherein the product is obtainable from the reaction of the reagent in the presence of the enzyme.

24. The capsule of claim 23, wherein the shell is obtainable from the complexation of a composition comprising a host and one or more building blocks having suitable host guest functionality thereby to form a supramolecular cross-linked network.

25. A capsule having a shell of material that is a supramolecular cross-linked network, wherein the capsule encapsulates an enzyme, and the enzyme is present at 50 wt % or more, as a percentage of the total amount of component and the capsule shell.

26. The capsule according to claim 25, wherein the shell is obtainable from the complexation of a composition comprising a host and one or more building blocks having suitable host guest functionality thereby to form a supramolecular cross-linked network.

27. The capsule according to claim 25, wherein the shell has a thickness of at most 20 μm.

28. The capsule according to claim 25, wherein the enzyme is present at a concentration of at least 0.5 mg/mL.

29. A method of releasing an encapsulant from a capsule, the method comprising the steps of:
(i) providing a capsule having a shell which is obtainable from the complexation of a composition comprising a host, and one or more building blocks having suitable guest functionality thereby to form a supramolecular cross-linked network, wherein the capsule encapsulates a component;
(ii) diluting the capsule, thereby to release the encapsulant from the capsule.

30. The method of claim 29, wherein, step (ii) includes subsequently drying the formed capsule thereby to reduce a water content of the capsule.

31. The method of claim 29, wherein the capsule is diluted in water.

32. A cleaning composition comprising a capsule, the capsule having a shell which is obtainable from the complexation of a composition comprising a host, and one or more building blocks having suitable guest functionality thereby to form a supramolecular cross-linked network, wherein the capsule encapsulates an enzyme.

33. The cleaning composition of claim 32, wherein the enzyme is selected from the group consisting of protease, amylase, mannanase, and cellulase enzymes.
